(19) United States
(12) Patent Application Publication
(10) Pub. No.: US 2025/0374212 A1
(43) Pub. Date: Dec. 4, 2025

(54) IRREGULAR SSB BEAM PATTERN FOR NETWORK ENERGY SAVING

(71) Applicant: QUALCOMM Incorporated, San Diego, CA (US)

(72) Inventors: Jing DAI, Beijing (CN); Chao WEI, Beijing (CN); Liangming WU, Beijing (CN); Min HUANG, Beijing (CN); Hao XU, Beijing (CN); Sony AKKARAKARAN, Poway, CA (US)

(21) Appl. No.: 18/707,842

(22) PCT Filed: Jan. 10, 2022
(86) PCT No.: PCT/CN2022/071008

§ 371 Date: May 6, 2024

(51) Int. Cl. H04W 56/00; H04B 7/06; H04W 72/11; H04W 74/0833

(52) U.S. Cl. CPC H04W 56/0015; H04B 7/0626; H04W 72/11; H04W 74/0833

(57) ABSTRACT

Aspects presented herein may improve network energy saving by enabling a base station to transmit SSBs in a set of SSBs with different periodicities. In one aspect, a base station configures each SSB in a set of SSBs with an SSB transmission periodicity for a time period, the time period including multiple SSB burst set transmission occasions, where at least a first SSB and a second SSB in the set of SSBs are configured with different SSB transmission periodicities. The base station transmits the set of SSBs based on a corresponding SSB transmission periodicity of each SSB over the time period.

### TECHNICAL FIELD

The present disclosure relates generally to communication systems, and more particularly, to wireless communication involving synchronization signal block (SSB).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus configures each SSB in a set of SSBs with an SSB transmission periodicity for a time period, the time period including multiple SSB burst set transmission occasions, where at least a first SSB and a second SSB in the set of SSBs are configured with different SSB transmission periodicities. The apparatus transmits the set of SSBs based on a corresponding SSB transmission periodicity of each SSB over the time period.

In an aspect of the disclosure, a method, a computer-readable medium, and an apparatus are provided. The apparatus receives, from a base station, information indicative of an SSB transmission periodicity configured for each SSB in a set of SSBs for a time period, the time period including multiple SSB burst set transmission occasions, where at least a first SSB and a second SSB in the set of SSBs are configured with different SSB transmission periodicities. The apparatus receives, from the base station, at least one SSB in the set of SSBs based on a corresponding SSB transmission periodicity for the at least one SSB.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example synchronization signal block (SSB) in accordance with various aspects of the present disclosure.

FIG. 5 is a diagram illustrating an example of information that may be included in a physical broadcast channel (PBCH) of an SSB in accordance with various aspects of the present disclosure.

FIG. 6 is a communication flow illustrating example system information block (SIB) transmissions in accordance with various aspects of the present disclosure.

FIG. 7 is a diagram illustrating an example of SS/PBCH block locations for 15 kHz subcarrier spacing (SCS) in accordance with various aspects of the present disclosure.

FIG. 8 is a diagram illustrating an example of SS/PBCH block locations for 30 kHz SCS in accordance with various aspects of the present disclosure.

FIG. 9 is a diagram illustrating an example of SS/PBCH block locations for 30 kHz SCS in accordance with various aspects of the present disclosure.

FIG. 10 is a diagram illustrating an example scenario where different SSBs beams may have different traffic at a given period in accordance with various aspects of the present disclosure.

FIG. 11 is a communication flow illustrating an example of a base station configuring different SSB transmission periodicities for different SSB beams based on statistics associated with the SSB beams in accordance with various aspects of the present disclosure.

FIG. 12 is a diagram illustrating examples of configuring SSB transmission periodicities for SSB beams in accordance with various aspects of the present disclosure.

FIG. 13 is a diagram illustrating an example benefit of configuring different SSB beams with SSB transmission periodicities in accordance with various aspects of the present disclosure.

FIG. 14 is a diagram illustrating an example mapping between SSBs and random-access channel (RACH) occasions (ROs) in accordance with various aspects of the present disclosure.

FIG. 15 is a diagram illustrating an example mapping between SSBs and ROs for an irregular SSB pattern in accordance with various aspects of the present disclosure.

FIG. 16 is a diagram illustrating an example mapping between SSBs and ROs for an irregular SSB pattern in accordance with various aspects of the present disclosure.

FIG. 17 is a diagram illustrating an example of using released SSBs for other communications in accordance with various aspects of the present disclosure.

FIG. 18 is a flowchart of a method of wireless communication in accordance with various aspects of the present disclosure.

FIG. 19 is a flowchart of a method of wireless communication in accordance with various aspects of the present disclosure.

FIG. 20 is a diagram illustrating an example of a hardware implementation for an example apparatus in accordance with various aspects of the present disclosure.

FIG. 21 is a flowchart of a method of wireless communication in accordance with various aspects of the present disclosure.

FIG. 22 is a diagram illustrating an example of a hardware implementation for an example apparatus in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

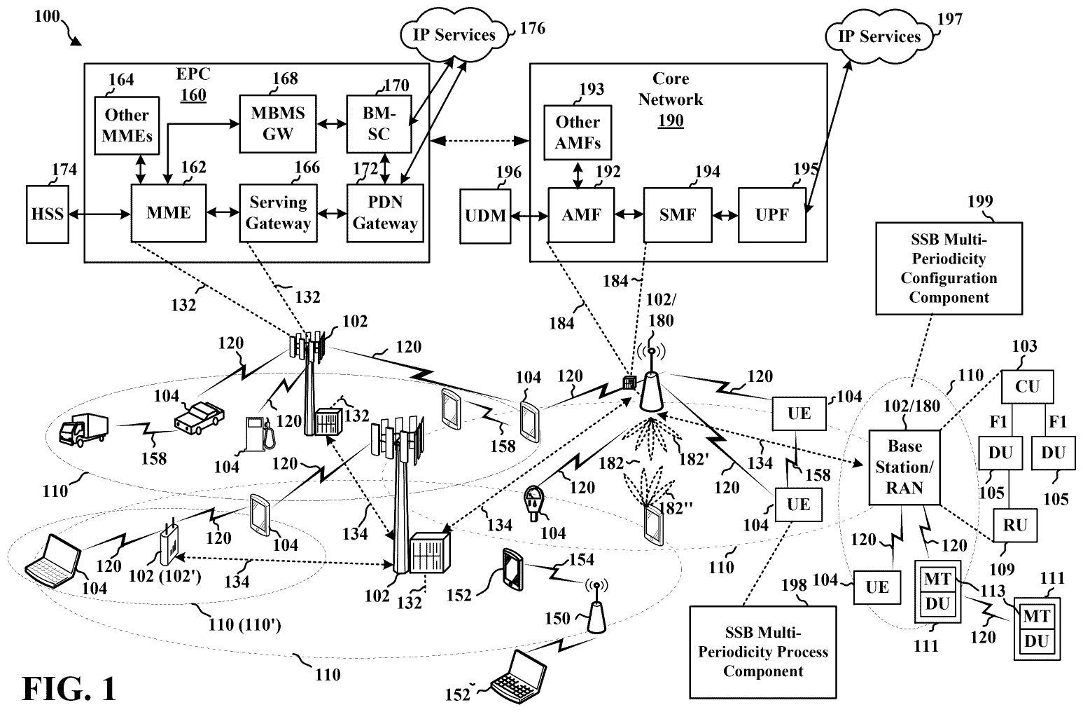

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve network energy saving by enabling a base station (or TRPs of the base station) to transmit SSBs in a set of SSBs with different periodicities. Aspects presented herein may enable a base station to transmit SSBs via multiple transmission beams of the base station, where different transmission beams may transmit their corresponding SSBs with different periodicities at a given time based at least in part on the probabilities and/or statistics of UEs accessing the base station via the different transmission beams during the given time. For example, in one aspect of the present disclosure, an SSB in a SSB burst set of a base station may be configured with a SSB transmission periodicity for a given period that is based on the statistics/traffic of an SSB beam used for transmitting the SSB for that given period. Thus, the periodicity for an SSB (e.g., a first SSB) in the SSB burst set may be different form another SSB (e.g., a second SSB) in the SSB burst set.

In certain aspects, the base station 102/180 may include an SSB multi-periodicity configuration component 199 configured to transmit SSBs in an SSB burst set via multiple transmission beams of the base station, where different SSBs may be transmitted with different SSB transmission periodicities at a given time to achieve energy saving. In one configuration, the SSB multi-periodicity configuration component 199 may configure each SSB in a set of SSBs with an SSB transmission periodicity for a time period, the time period including multiple SSB burst set transmission occasions, where at least a first SSB and a second SSB in the set of SSBs are configured with different SSB transmission periodicities. In such configuration, the SSB multi-periodicity configuration component 199 may transmit the set of SSBs based on a corresponding SSB transmission periodicity of each SSB over the time period.

In certain aspects, the UE 104 may include an SSB multi-periodicity process component 198 configured to receive or monitor different SSBs from a base station based on different periodicities. In one configuration, the SSB multi-periodicity process component 198 may receive, from a base station, information indicative of an SSB transmission periodicity configured for each SSB in a set of SSBs for a time period, the time period including multiple SSB burst set transmission occasions, where at least a first SSB and a second SSB in the set of SSBs are configured with different SSB transmission periodicities. In such configuration, the SSB multi-periodicity process component 198 may receive, from the base station, at least one SSB in the set of SSBs based on a corresponding SSB transmission periodicity for the at least one SSB.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT) 113. The DU 105 of an IAB node 111 may operate as a parent node, and the MT 113 may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

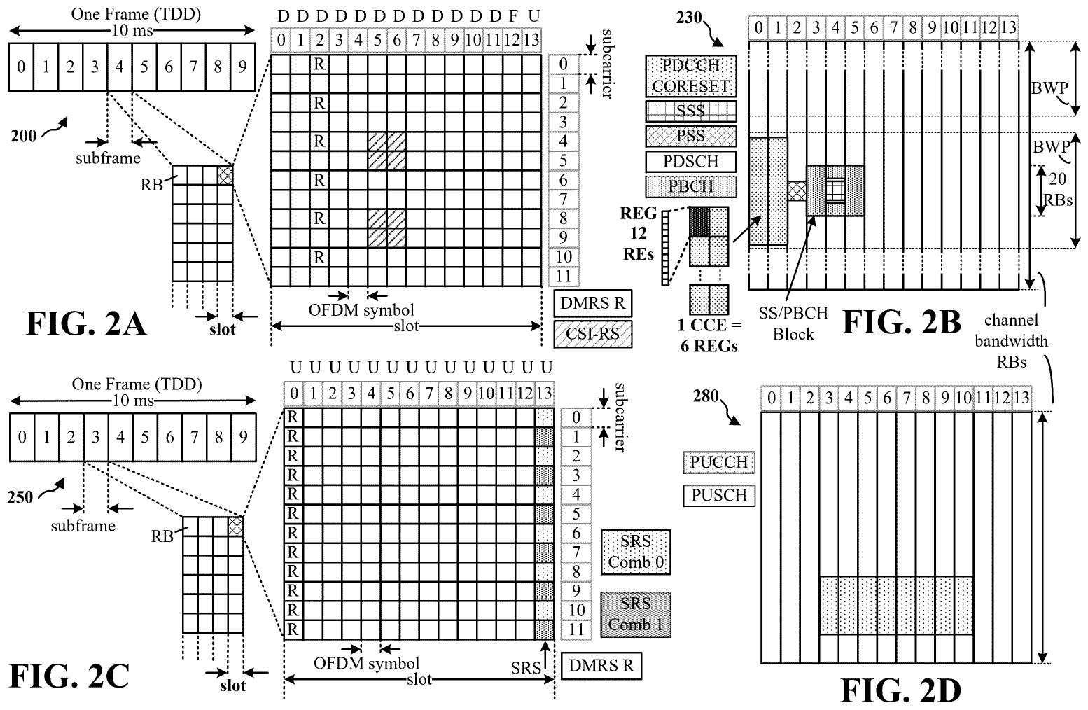

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ} *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

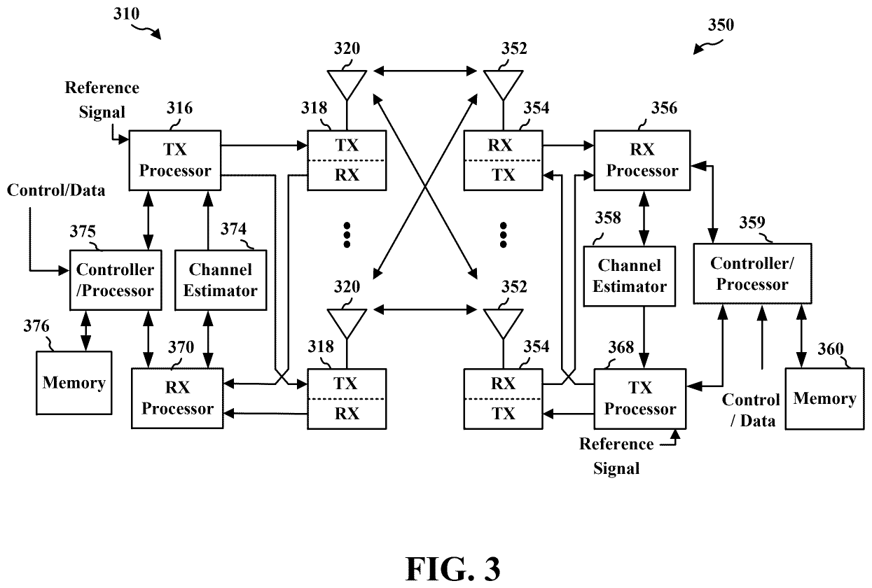

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the SSB multi-periodicity process component 198 of FIG. 1.

At least one of the TX processor 316, the RX processor 370, and the controller/processor 375 may be configured to perform aspects in connection with the SSB multi-periodicity configuration component 199 of FIG. 1.

A UE may perform a cell search to obtain time and/or frequency synchronization with a cell and to obtain a cell identifier (ID), such as a physical layer cell ID (PCI) of the cell. The UE may also measure the signal quality and obtain other information about the cell based on the PCI. The UE may perform the cell search for a defined frequency range before the UE selects or re-selects a cell. In some examples, a UE may perform the cell search when the UE is powered ON, when the UE is moving (e.g., under mobility in a connected mode), and/or when the UE is in an idle/inactive mode (e.g., the UE may perform a cell reselection procedure after the UE camps on a cell and stays in the idle mode), etc.

To perform the cell search (e.g., the initial cell search and/or the cell reselection, etc.), a UE may use/decode synchronization signal(s) transmitted from one or more cells (e.g., transmitted from a base station or a transmission reception point (TRP) of the base station), where the UE may obtain or derive information related to the one or more cells and/or their access information based on the synchronization signal(s). In one example, a cell may provide one or more types of synchronization signals, such as a primary synchronization signal (PSS) and a secondary synchronization signal (SSS), along with a physical broadcast channel (PBCH), in a synchronization signal block (SSB) to UEs within its transmission range, e.g., as described in connection with FIG. 2B. Then, the UEs may perform the cell search based on the SSB. In some examples, a UE may first decode a PBCH before the UE receives other system information transmitted on a physical downlink shared channel (PDSCH).

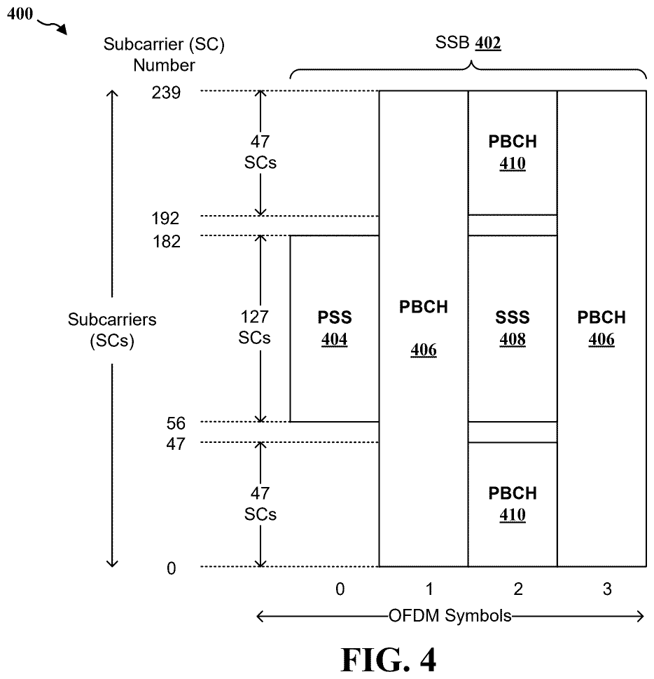

FIG. 4 is a diagram 400 illustrating an example SSB in accordance with various aspects of the present disclosure. An SSB 402 may span four (4) OFDM symbols with one (1) symbol for a PSS 404, two (2) symbols for PBCH 406, and one (1) symbol with an SSS 408 and PBCH 410 that are frequency division multiplexed (FDMed). The length of an OFDM symbol or a slot may be scaled based on subcarrier spacing (SCS), and there may be seven (7) or fourteen (14) symbols per slot. For example, different frequency ranges may have different SCS, where 15, 30, and/or 60 KHz SCS may be used for lower frequency bands (e.g., the FR1), and 60, 120, and/or 240 kHz SCS may be used for higher frequency bands (e.g., the FR2). In one example, the PSS 404 may be mapped to 127 subcarriers (SCs) around the center frequency of the SSB 402, where the PSS 404 may use a length 127 frequency domain-based M-sequence (e.g., made up of 127 M-sequence values), which may have up to three (3) possible sequences. The M-sequence may also be referred to as a maximum length sequence (MLS), which may be a type of pseudorandom binary sequence. The SSS 408 may also be mapped to 127 SCs and may use a length 127 frequency domain-based Gold Code sequence (e.g., two (2) M-sequences are used), which may have up to 1008 possible sequences. A UE may use the information included in the PSS 404 and/or the SSS 408 for downlink frame synchronization and for determining the physical cell ID of the cell. The PBCH 406 and/or 410 may be modulated with quadrature phase shift keying (QPSK), which may be coherently demodulated by a UE using the associated DMRS carried in the PBCH 406 and/or 410. The PBCH 406 and/or 410 may include the master information block (MIB) part of the MAC layer broadcast channel (BCH). The other part of the BCH, such as the system information block (SIB), may be included in a PDSCH allocation encoded with the system information-radio network temporary identifier (SI-RNTI).

During an initial cell search or a cell reselection, a UE searching for a cell may use a sliding window and correlation technique to look for the PSS 404. For example, the UE may use a sliding window with a length of one (1) symbol to try to correlate one or more possible PSS sequences as the UE may not know which SCs are used by the PSS 404. In addition, due to the Doppler, internal clock frequency shifts, and/or other frequency errors associated with the PSS 404, the UE may use a different timing hypothesis and/or frequency hypothesis to account for these errors. For example, for each timing hypothesis, the UE may try to use all three sequences+N frequency hypotheses to account for the Doppler, internal clock frequency shifts, and any other frequency errors, etc.

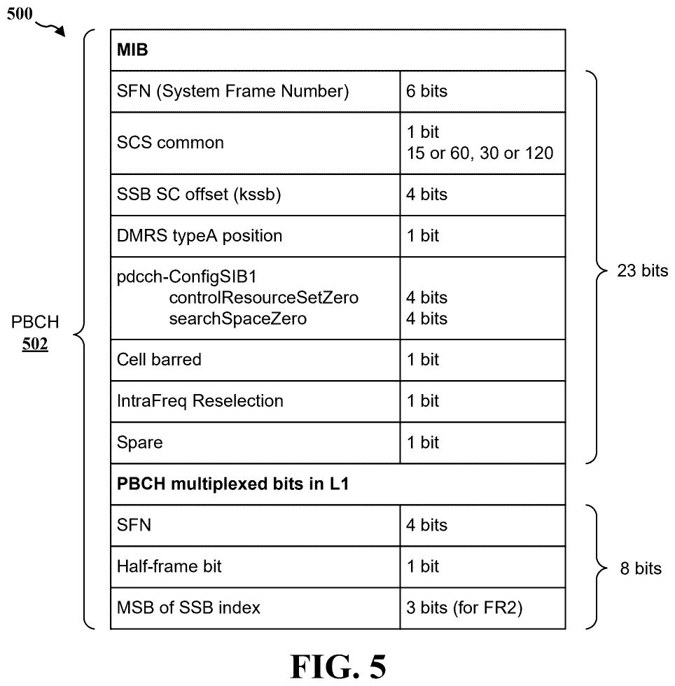

In some examples, based on the PSS 404 and/or the SSS 408, the UE may know the timing and/or frequency of the PBCH 406 and 410 (collectively as the PBCH) within the SSB 402. The PBCH may include 576 resource elements (REs) (e.g., 1 RE=1 SC×1 symbol), where 576 REs=240×2 (at symbols one and threc)+(48+48) (at symbols two)=number of REs. The PBCH may carry the MIB and DMRS, and the PBCH may be modulated with QPSK. The UE may perform coherent demodulation of the PBCH based on the DMRS carried in the PBCH. In addition, the UE may use the DMRS to perform channel estimation. In one example, the DMRS may carry, or be used by the UE to determine, three (3) least significant bits (LSB) (e.g., for the FR2) of an SSB index per half frame from a DMRS sequence index. For example, under the FR2, a base station or one or more transmission reception points (TRPs) of a base station may communicate with a UE using more than one beam (e.g., up to 64 beams), where each beam may correspond to one beam index. In some examples, each beam index may further be associated with an SSB index, such that the base station may indicate to the UE which beam(s) may be used by the base station for transmission through the SSB index. As a base station or TRP(s) of a base station may use up to 64 beams, the SSB index may be six (6) bits long (e.g., 26=64), where three (3) bits may be carried in the DMRS, and the other three bits may be multiplexed with the PBCH (e.g., as shown by “MSB of SSB index” within FIG. 5). In some examples, the DMRS may be interleaved (e.g., in frequency) with the PBCH data at every 4^{th} SC (e.g., RE), such that the DMRS may include 144 REs (e.g., 60×2+12+12). The UE may use the DMRS, the SSS (e.g., 508) and/or the PSS (e.g., 504) signals in an SSB (e.g., 502) to refine the frequency offset estimation.

FIG. 5 is a diagram 500 illustrating an example of information that may be included in a PBCH of an SSB in accordance with various aspects of the present disclosure. A PBCH 502 may be thirty-one (31) bits long, such as for a network operating within the FR2, and the PBCH 502 may include one or more parameters that may be used by a UE to decode a system information block type one (SIB1) message (e.g., SIB1 PDSCH). For example, the MIB within the PBCH 502 may carry a pdcch-ConfigSIB1 field that includes a parameter for an initial CORESET (e.g., a controlResourceSetZero parameter) and a parameter for an initial search space set (e.g., a searchSpaceZero parameter). The controlResourceSetZero parameter may guide the UE to a CORESETO, where the CORESETO may carry a PDCCH that has information for scheduling a SIB1 PDSCH. For example, the controlResourceSetZero parameter may be four (4) bits long, and the UE may use this parameter to determine a multiplexing pattern (discussed below) and the CORESETO's frequency offset, number of resource blocks (RBs) and/or number of symbols, etc. The searchSpaceZero parameter may be four (4) bits long, and the UE may use this parameter to determine the CORESETO's time location. Thus, based on the information included in the controlResourceSetZero parameter and/or the searchSpaceZero parameter, the UE may identify or determine the location (e.g., in time and/or frequency) of the CORESETO.

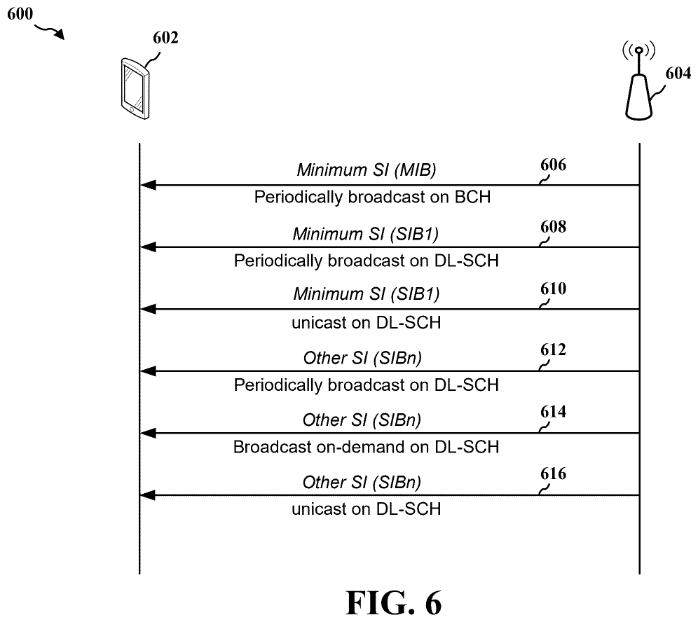

As described in connection with FIGS. 2B and 4, system information (SI) (e.g., the PBCH) may include a MIB and a number of SIBs. FIG. 6 is a communication flow 600 illustrating example SIB transmissions in accordance with various aspects of the present disclosure. As shown by the communication flow 600, the system information may be divided into multiple minimum SI (e.g., 606, 608, 610) and other SI (e.g., 612, 614, 616). The minimum SI (e.g., 606, 608, 610) may include basic information for a UE 602's initial access to a cell 604 (e.g., base station) and information for acquiring any other system information. For example, minimum SI may include a MIB 606, which may contain cell barred status information and physical layer information of the cell 604 for receiving further system information (e.g., CORESET #0 configuration). The cell 604 may broadcast the MIB 606 periodically on a broadcast channel (BCH). The minimum SI may also include a SIB1 (e.g., 608 and/or 610), where the SIB1 may define the scheduling of other system information blocks and may contain information for the UE's initial access to a base station, such as the random access parameters. For examples, the SIB1 may include information regarding the availability and scheduling of other SIBs (e.g., mapping of SIBs to SI message, periodicity, SI-window size, etc.). The SIB1 may also indicate whether one or more SIBs is provided based on on-demand, in which case, it may also provide physical random access channel (PRACH) configuration for the UE to request for the SI. PRACH may be an uplink channel used by a UE for connection request purpose, such as used by the UE to carry the RACH transport channel data. The SIB1 may further contain RRC information that is common for all UEs and cell barring information applied to the unified access control. The SIB1 (e.g., 608 and/or 610) may be referred to as the remaining minimum SI (RMSI), which may be periodically broadcasted by the cell 604 on a downlink-share channel (DL-SCH) (e.g., using SIB 1 608) or transmitted to a dedicated UE (e.g., RRC connected) on the DL-SCH (e.g., using SIB 1 610). The other SI (e.g., SIBn 612, 614, 616) may include other SIBs not being broadcasted in the minimum SI (e.g., 606, 608, 610). The other SI may be periodically broadcasted by the cell 604 on the DL-SCH, broadcasted on-demand on the DL-SCH (e.g., requested by the UE 602), or transmitted in a dedicated manner on the DL-SCH to one or more UEs including the UE 602. For example, SIB2 may include cell re-selection information, SIB3 may include information about the serving frequency and intra-frequency of the neighboring cells relevant for cell re-selection, etc.

In order for a UE to initiate a RACH procedure with a base station, the base station may be configured to continuously broadcast SSBs (e.g., the SSB 402) at a defined periodicity. As such, in some scenarios, when a base station includes an empty load or low load (e.g., with low traffic), the energy mainly consumed at the base station may be the SSB/SIB transmissions and preamble detections. For example, a base station may be configured with a default assumption that a UE may initiate a RACH procedure anytime, on detection of any SSB occasion (beam direction) during a cell search. Thus, a base station may be able to achieve power/energy saving by changing the periodicity of the SSB/SIB transmissions. For example, a shorter periodicity may consume more power at the base station compared to a longer periodicity as the base station may transmit more SSBs/SIBs in a same period of time (e.g., number of SSB occasions is reduced for the longer periodicity). In some examples, a network or a base station may support SSB periodicities of 5, 10, 20, 40, 80, and/or 160 ms, and the number of SSB occasions within an SSB burst set may be configurable based on a bitmap. In some examples, during a cell search, a UE may be configured to assume the (default) periodicity of an SSB burst set as 20 ms (e.g., 2 frames), but the actual periodicity may be up to network implementation (e.g., 5, 10, 20, 40, 80, and/or 160 ms configurable by SIB1).

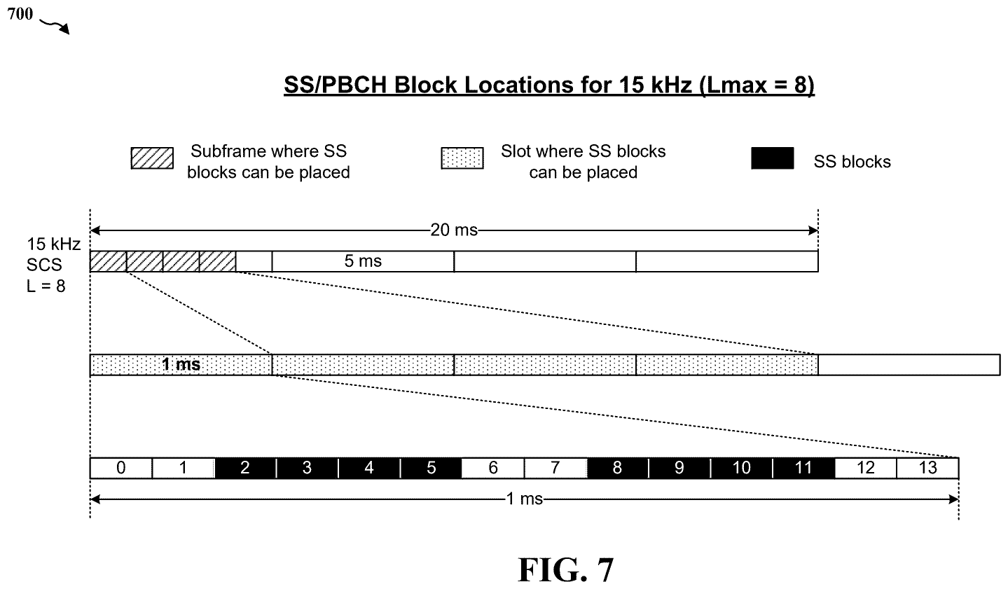

An SSB burst set may refer to a set of SSBs transmitted in a defined period, and the number of SSB occasions (beams) configured for an SSB burst set may be fixed over each periodicity. In addition, an SSB burst set may be associated with beam sweeping, where different SSBs in an SSB burst set may be transmitted on different transmission beams to cover an entire cell. For example, an SSB burst set may include a set of eight SSBs that are configured to be transmitted via eight SSB beams of a base station within 5 ms (e.g., a half frame) based on beam sweeping. In some examples, the maximum number of SSBs (“Lmax”) that may be configured for an SSB burst set (or beam directions for beam sweeping) may depend on the corresponding carrier frequency. For example, an SSB burst set may have a maximum number of 4 SSBs configured in the first 2 slots when the carrier frequency is less than or equal to 3 GHZ (e.g., carrier frequency ≤3 GHz, Lmax=4), whereas an SSB burst set may have a maximum number of 8 SSBs configured in the first 4 slots when the carrier frequency is under FR1 and is greater than or equal to 3 GHZ (e.g., FR1 carrier frequency ≥3 GHz, Lmax=8), etc. In another example, when the carrier frequency is under FR2 (e.g., for mmW), an SSB burst set may have a maximum number of 64 SSBs. In other words, for FR1, a maximum of 4 or 8 different beams may be used for beam sweeping, and for FR2, a maximum of 64 different beams may be used for beam sweeping, etc. FIG. 7 is a diagram 700 illustrating an example of SS/PBCH block locations for 15 kHz subcarrier spacing (SCS) in accordance with various aspects of the present disclosure. In one example, for 15 kHz SCS, an SSB burst set may include at most 4 or 8 SSBs, located in the first 2 or 4 slots (e.g., slots {0, 1} or slots {0, 1, 2, 3}), and at symbols {2, 3, 4, 5} and {8, 9, 10, 11} of each slot. The actual transmitted SSB locations may be indicated/configured by bitmap parameter(s) in an SIB1 message.

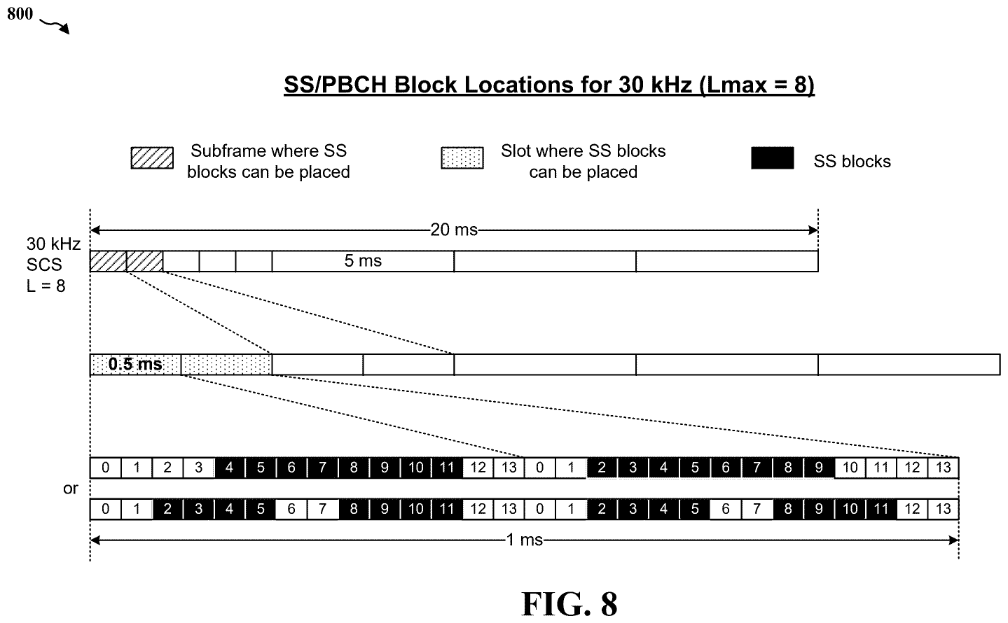

FIG. 8 is a diagram 800 illustrating an example of SS/PBCH block locations for 30 kHz SCS in accordance with various aspects of the present disclosure. In one example, for 30 kHz SCS, an SSB burst set may include at most 8 SSBs, located in the first 2 slots (e.g., slots {0, 1}). In one example, the SSBs may be located and at symbols {4, 5, 6, 7} and {8, 9, 10, 11} of the first slot and at symbols {2, 3, 4, 5} and {6, 7, 8, 9} of the second slot. In another example, the SSBs may be located and at symbols {2, 3, 4, 5} and {8, 9, 10, 11} of each slot. Similarly, the actual transmitted SSB locations may be indicated/configured by bitmap parameter(s) in an SIB1 message.

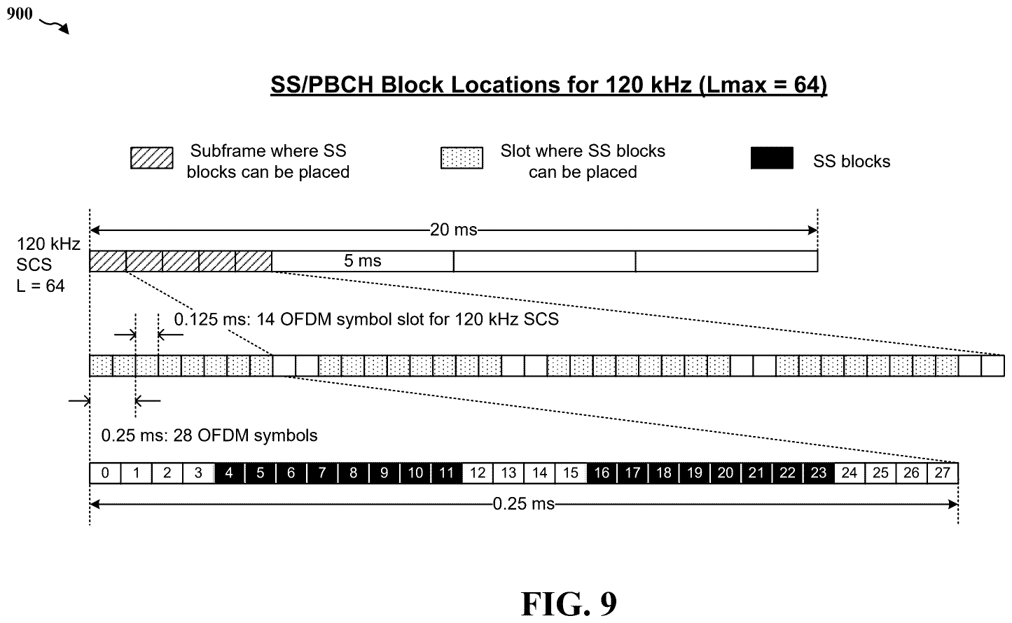

FIG. 9 is a diagram 900 illustrating an example of SS/PBCH block locations for 30 kHz SCS in accordance with various aspects of the present disclosure. In one example, for 120 kHz SCS, an SSB burst set may include at most 64 SSBs in a half frame, and the SSBs may be located and at symbols {4, 5, 6, 7}, {8, 9, 10, 11}, {16, 17, 18, 19}, and {20, 21, 22, 23} of each slot. Similarly, the actual transmitted SSB locations may be indicated/configured by bitmap parameter(s) in an SIB1 message.

While increasing the periodicity of SSB transmissions at a base station may achieve energy saving, it may also increase the latency for a UE performing cell search. For example, if the periodicity of the SSB transmissions in a cell is increased from 20 ms to 160 ms, a UE may detect one SSB in every 160 ms instead of eight SSBs. In addition, an SSB burst set may be specified to have a beam sweeping covering an entire cell, which may be associated with the network deployment and may be difficult to reduce (e.g., reducing it may result in coverage holes). For examples, for an SSB burst set with eight (8) SSBs, such as shown by FIG. 8, if all SSBs are transmitted via different transmission beams and toward different directions, reducing the number of SSBs (e.g., to six SSBs, four SSBs, etc.) to achieve energy saving may result in SSBs not being transmitted toward certain direction(s), which may cause coverage hole(s) (referring to an area not being covered by SSB transmission). In other words, the beam sweeping may not cover the entire cell if the number of SSBs are reduced in an SSB burst set.

Aspects presented herein may improve network energy saving by enabling a base station (or TRPs of the base station) to transmit SSBs in a set of SSBs with different periodicities. Aspects presented herein may enable a base station to transmit SSBs via multiple transmission beams of the base station, where different transmission beams may transmit their corresponding SSBs with different periodicities at a given time based at least in part on the probabilities and/or statistics of UEs accessing the base station via the different transmission beams during the given time. For example, in one aspect of the present disclosure, an SSB in a SSB burst set of a base station may be configured with a SSB transmission periodicity for a given period that is based on the statistics/traffic of an SSB beam used for transmitting the SSB for that given period. Thus, the periodicity for an SSB (e.g., a first SSB) in the SSB burst set may be different form another SSB (e.g., a second SSB) in the SSB burst set.

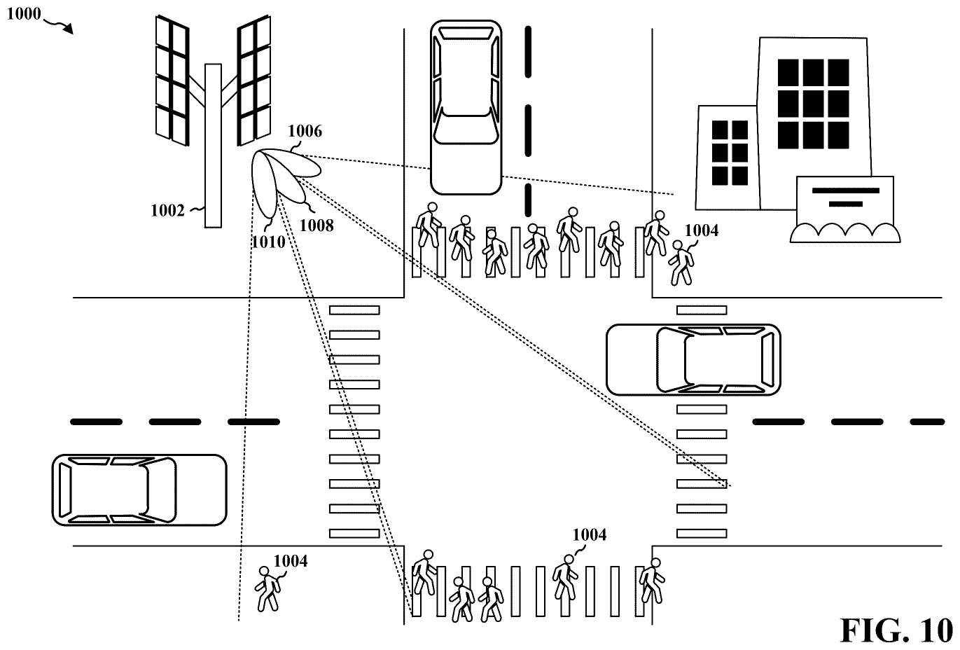

FIG. 10 is a diagram 1000 illustrating an example scenario where different SSBs beams may have different traffic at a given period in accordance with various aspects of the present disclosure. In some scenarios, the probabilities or statistics of UEs initiating RACH procedures/processes may be different for different SSB transmission beams (hereafter “SSB beams”). For example, a base station 1002 may include multiple SSB beams for transmitting SSBs periodically, and the multiple SSB beams may include at least a first SSB beam 1006 for transmitting a first SSB (e.g., SSB #1) in an SSB burst set, a second SSB beam 1008 for transmitting a second SSB (e.g., SSB #2) in the SSB burst set, and a third SSB beam 1010 for transmitting a third SSB (e.g., SSB #3) in the SSB burst set, where each of the three SSB beams may be pointing toward a portion of an intersection. As the population distribution (e.g., number of UEs carried/used by pedestrians) at the intersection may keep changing (e.g., it may variate in tens of seconds), each SSB beam of the base station 1002 may have a different probability of UEs attempting to perform RACH procedures (e.g., to receive and decode SSBs for RACH procedures). For example, at a given period, the first SSB beam 1006 and the second SSB beam 1008 of the base station 1002 may be pointing to a higher population area of the intersection, where the higher population area may include a higher number of UEs carried by pedestrians 1004. On the other hand, the third SSB beam 1010 may be pointing to a lower population area of the intersection, which may have a lower number of UEs carried by pedestrians 1004. As such, different SSB beams of the base station 1002 may have different traffic or likelihoods of receiving RACH procedure requests at different times. In addition, there may also be low-mobility idle/inactive UEs distributed unevenly within a cell, where data may arrive at the base station 1002 randomly.

In one aspect of the present disclosure, to improve energy saving at a base station (e.g., the base station 1002), the statistics/probabilities associated with the SSB beams may be utilized/exploited for SSB transmission reduction in beam and/or spatial dimension. For example, SSB(s) transmitted via SSB beam(s) with a higher probability of UEs performing RACH procedures (hereafter “UE RACH”) in a period may be configured with a denser periodicity (e.g., a shorter periodicity) compared to SSB(s) transmitted via SSB beam(s) with a lower probability of UE RACH in that period. As such, the base station may transmit different (e.g., reduced) SSB beam pattern for each SSB burst set transmission occasion. In addition, from network implementation perspective, big data and/or machine learning (ML) algorithm may be used for predicting an SSB beam pattern for the base station over a period of time (e.g., for predicting the traffic of each SSB beam at different time periods).

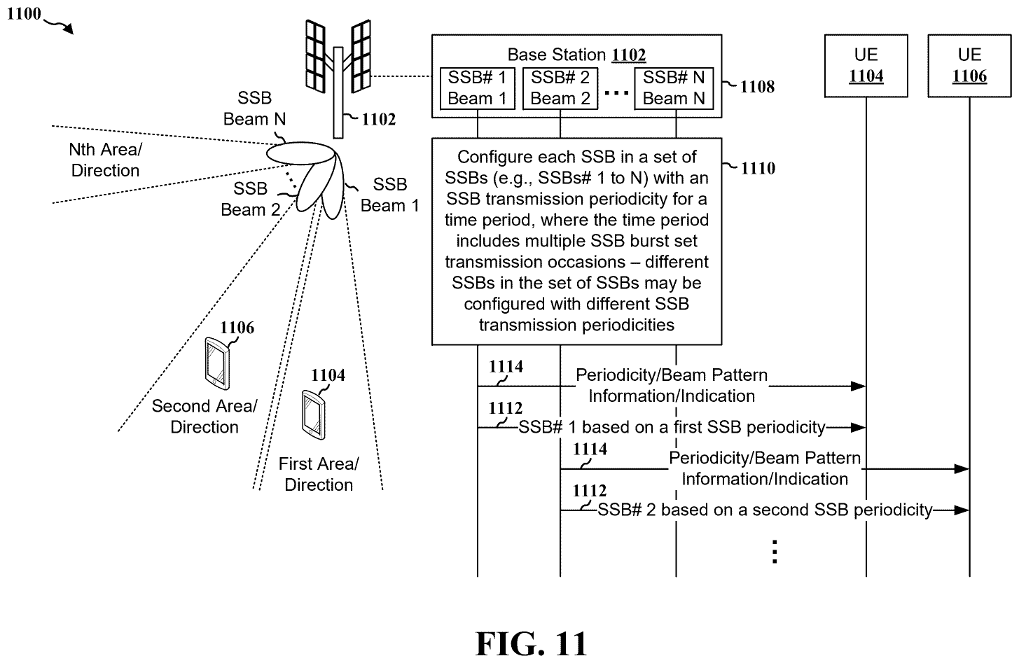

FIG. 11 is a communication flow 1100 illustrating an example of a base station configuring different SSB transmission periodicities for different SSB beams based on statistics associated with the SSB beams in accordance with various aspects of the present disclosure. The numberings associated with the communication flow 1100 do not specify a particular temporal order and are merely used as references for the communication flow 1100. For purposes of the present disclosure, a transmission beam of a base station that is used for transmitting SSB may be referred to as an SSB beam or an SSB transmission beam; the periodicity in which SSBs are transmitted from an SSB beam may be referred to as an SSB periodicity or an SSB transmission periodicity; and each occasion which the base station transmits SSB(s) may be referred to as an SSB transmission occasion or an SSB burst set transmission occasion. In some examples, when a base station transmits a maximum number of SSBs configurable/allowable in an SSB burst set transmission occasion, the SSBs transmitted in that SSB burst set transmission occasion may be referred to as a “full set of SSBs,” whereas if the base station transmits less than the maximum number of SSBs configurable/allowable in an SSB burst set transmission occasion, the SSBs transmitted in that SSB burst set transmission occasion may be referred to as a “non-full set of SSBs.” For example, if an SSB burst set is configured with eight (8) SSBs, a full set of SSB in an SSB burst set transmission occasion may indicate a base station transmits at most eight SSBs in that SSB burst set transmission occasion, and a non-full set of SSB in an SSB burst set transmission occasion may indicate the base station transmit less than eight SSBs (e.g., zero (0) to seven (7) SSBs) in that SSB burst set transmission occasion. Note that a “full set of SSBs” does not indicate Lmax configured for SSBs/SSB burst sets is to be achieved. The base station may transmit number of SSBs that is smaller than Lmax based on a corresponding bitmap, such as described in connection with FIGS. 7 to 9. As shown at 1108, a base station 1102 may include multiple SSB beams that are used for transmitting SSBs toward different areas/directions, where the SSBs may be used by a UE for initiating a RACH procedure, such as described in connection with FIGS. 4 to 6. For example, the base station 1102 may include a first SSB beam (beam 1) that transmits a first SSB (SSB #1) in an SSB burst set towards a first area/direction, a second SSB beam (beam 2) that transmits a second SSB (SSB #2) in the SSB burst set towards a second area/direction, and up to an Nth SSB beam (beam N) that transmits an Nth SSB (SSB #N) in the SSB burst set towards an Nth area/direction, etc. There may or may not be an overlap between transmission areas/directions of two SSB beams.

At 1110, the base station 1102 may configure each SSB in an SSB burst set (e.g., SSBs #1 to N in a full set of SSBs) with an SSB transmission periodicity for a time period (e.g., from 12:03:00 to 12:35:00, for half frame, for 15 seconds, etc.), where the SSB transmission periodicity configured for a particular SSB in the SSB burst set may be based at least in part on statistics associated with an SSB beam that is used for transmitting that particular SSB, such as a probability associated with a number of UEs communicating via the SSB beam during the time period (e.g., based on past UE traffic record associated with the SSB beam). In one aspect, a machine learning (ML) module or algorithm may be utilized for collecting the number of UEs performing RACH procedures (which may be referred to as “UE RACH”) for different time periods of a day. For example, as shown by Table 1 below, an ML module may collect numbers of UE RACH for different SSB beams at different time periods of a day, such as between every five minutes (e.g., 12:00:00-12:05:00, 12:05:00-12:10:00, . . . , etc.), and the ML module may perform the statistic collection for multiple days (e.g., for three months, for six months, or for a year, etc.).

TABLE 1
Example Statistics Associated with SSB Beams

| | SSB Beam 1 | SSB Beam 2 | SSB Beam N |
|---|---|---|---|
| | # of UE | # of UE | # of UE |
| Dec. 17, 2021 | RACH | RACH | RACH |
| 12:00:00-12:05:00 | 200 | 13 | 138 |
| 12:05:00-12:10:00 | 322 | 12 | 125 |
| 12:10:00-12:15:00 | 285 | 7 | 78 |
| 12:15:00-12:20:00 | 450 | 3 | 103 |
| 12:20:00-12:25:00 | 370 | 6 | 66 |

Then, based on the statistics collected for multiple days, the ML module may derive an average or a probability of UE RACH for each SSB beam. For example, as shown by Table 2 below, between 12:00:00 to 12:05:00 of a first day (e.g., 12/17), the first SSB beam of the base station 1102 may receive 200 UE RACH requests, between 12:00:00 to 12:05:00 of a second day (e.g., 12/18), the first SSB beam may receive 250 UE RACH requests, and between 12:00:00 to 12:05:00 of a third day (e.g., 12/19), the first SSB beam of the base station 1102 may receive 231 UE RACH requests, etc.

TABLE 2
Example Statistics Associated with SSB Beams

| SSB Beam 1 | 12/17 | 12/18 | 12/19 | Avg. |
|---|---|---|---|---|
| 12:00:00-12:05:00 | 200 | 250 | 231 | 227 |
| 12:05:00-12:10:00 | 322 | 277 | 301 | 300 |

Based on the numbers collected from the three-day period, the ML module may predict that, on average, there may be 227 UE RACHs via the first SSB beam between 12:00:00 to 12:05:00 of a given day (e.g., [200+250+231]=3=227), or that there may be a high probability of UEs performing UE RACH via the first SSB beam between 12:00:00 to 12:05:00 of a given day. For example, multiple probability thresholds may be defined for the base station, where the probability of UEs performing UE RACH may be classified as a high probability when the number of UE RACH exceeds 200, as a medium probability when the number of UE RACH is between 100 and 200, and as low probability when the number of UE RACH is below 100, etc.

After statistics and/or UE RACH probabilities associated with each SSB beam used for transmitting the SSBs in the SSB burst set (e.g., a full set of SSBs), the base station 1102 may configure an SSB transmission periodicity for each SSB in the SSB burst based at least in part on the statistics and/or UE RACH probabilities to achieve power saving. For example, based on the numbers collected by Table 1, the base station 1102 may determine that between 12:00:00 to 12:05:00 of a given day, there is a high number or a high probability of UE RACH for the first SSB beam. As such, the base station 1102 may configure a denser SSB transmission (e.g., a shorter SSB transmission periodicity) for the first SSB (or the first SSB beam) for that given period of time. On the other hand, based on the numbers collected by Table 1, the base station 1102 may determine that between 12:00:00 to 12:05:00 of a given day, there is a low number or a low probability of UE RACH for the second SSB beam. As such, the base station 1102 may configure a less dense SSB transmission (e.g., a longer SSB transmission periodicity) for the second SSB (or the second SSB beam) for that given period of time.

At 1112, the base station 1102 may transmit SSBs via their corresponding SSB beams (e.g., via the first SSB beam to the Nth SSB beam) based on their corresponding SSB transmission periodicities for different time periods, where different SSB beams or different sets of SSB beams may transmit SSBs at different periodicities for a given time period. For example, for a given time period (e.g., between 12:00:00 to 12:05:00), the base station 1102 may transmit the first SSB via the first SSB beam based on a first SSB transmission periodicity, and transmit the second SSB via the second SSB beam based on a second SSB transmission periodicity that is different from the first SSB transmission periodicity. As such, by configuring different periodicities for different SSB beams based at least in part on their statistics (e.g., past UE RACH data collected), the base station 1102 may improve energy saving.

In one aspect of the present disclosure, a network or a base station may configure the SSB transmission periodicities for the SSB beams of the base station in a variety of ways, such as based on configuring multiple SSB beam patterns for multiple transmission instances, configuring a periodicity for each SSB or SSB beam individually, and/or configuring periodicities for actual SSBs transmitted, etc.

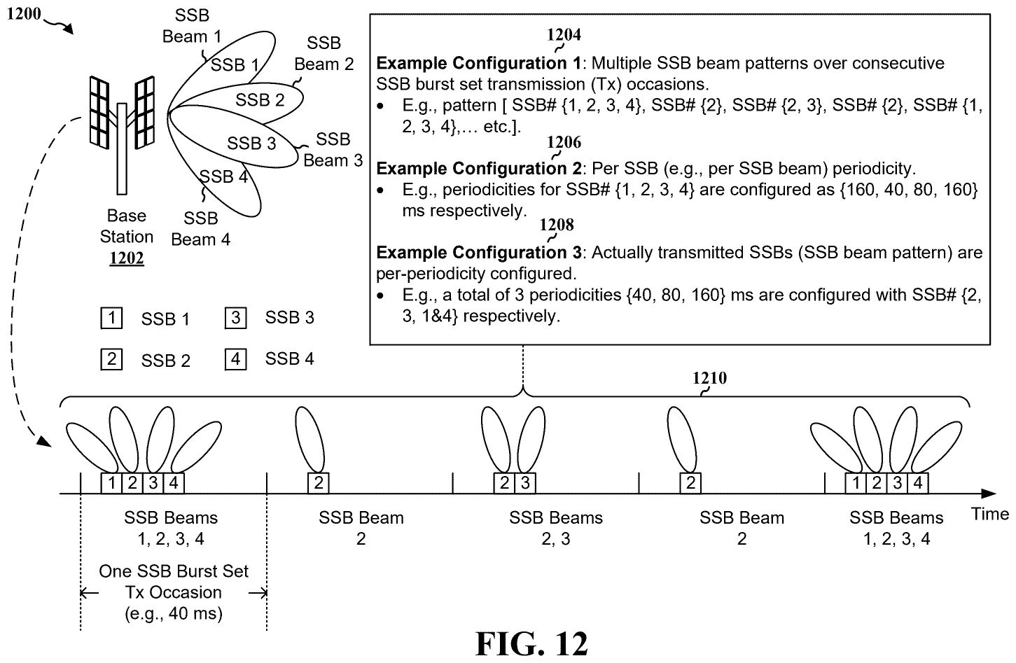

FIG. 12 is a diagram 1200 illustrating examples of configuring SSB transmission periodicities for SSB beams in accordance with various aspects of the present disclosure. A base station 1202 (e.g., the base station 1102) may be configured to transmit a maximum number of four SSBs via four SSB beams (e.g., Lmax=4). For example, the base station 1102 may transmit a first SSB (SSB #1) via a first SSB beam (SSB beam 1), a second SSB (SSB #2) via a second SSB beam (SSB beam 2), a third SSB (SSB #3) via a third SSB beam (SSB beam 3), and a fourth SSB (SSB #4) via a fourth SSB beam (SSB beam 4). The base station 1202 may transmit SSBs based on beam sweeping, such that each SSB beam of the base station 1202 may transmit its corresponding SSB towards a direction/area that is different from other SSB beams. A full set of SSB may indicate a transmission of all four SSBs (e.g., SSBs #1 to 4) in an SSB burst set transmission occasion, whereas a non-full set of SSB may indicate a transmission of less than four SSBs in an SSB burst set transmission occasion.

In one example, as shown at 1204, multiple SSB beam patterns over consecutive SSB burst set transmission occasions may be configured for a base station to transmit SSBs via multiple SSB beams over a period of time. For example, the base station 1202 may be configured to transmit SSBs #1, 2, 3, 4 (e.g., a full SSB set) at a first SSB burst set transmission instance, transmit SSB #2 (e.g., a non-full SSB set) at a second SSB burst set transmission instance, transmit SSBs #2, 3 (e.g., a non-full SSB set) at a third SSB burst set transmission instance, transmit SSB #2 (e.g., a non-full SSB set) at a fourth SSB burst set transmission instance, and transmit SSBs #1, 2, 3, 4 (e.g., a full SSB set) at a fifth SSB burst set transmission instance, such as shown at 1210.

In another example, as shown at 1206, each SSB in the SSB burst set or each SSB beam of the base station 1202 may be configured with its corresponding SSB transmission periodicity. For example, periodicities for SSBs #1, 2, 3, 4 may be configured as {160, 40, 80, 160} ms, respectively. As such, the base station may transmit SSBs #1 and 4 every 160 ms, transmit SSB #2 every 40 ms, and transmit SSB #3 every 80 ms, such as shown at 1210. In one example, an additional bitmap may be used for configuring the SSBs with their corresponding periodicities. For example, an additional bitmap {0100, 0010, 1001} may correspond to the three periodicities {40, 80, 160} ms, such that signaling overhead may be reduced. Note that the additional bitmap is different from the bitmap indicating actual transmitted SSB locations that is described in connection with FIGS. 7 to 9.

In another example, as shown at 1208, the actual transmitted SSBs (SSB beam pattern) may be per-periodicity configured for the base station 1202. For example, a total of three (3) periodicities {40, 80, 160} ms may be configured with SSB #{1, 2, 0&3}, respectively, to reduce signaling overhead. As such, the base station may transmit SSBs #1 and 4 every 160 ms, transmit SSB #2 every 40 ms, and transmit SSB #3 every 80 ms, such as shown at 1210. Similarly, an additional bitmap may be used for configuring the SSBs with their corresponding periodicities. For example, an additional bitmap {0100, 0010, 1001} may correspond to the three periodicities {40, 80, 160} ms, such that signaling overhead may be further reduced.

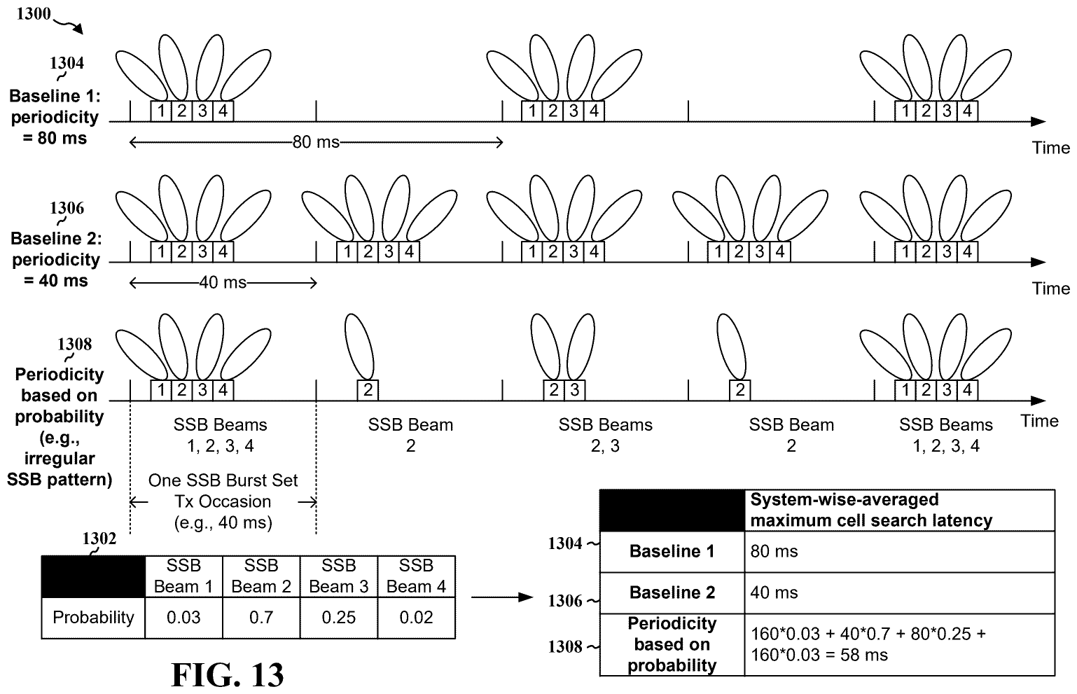

FIG. 13 is a diagram 1300 illustrating an example benefit of configuring different SSB beams with SSB transmission periodicities in accordance with various aspects of the present disclosure. As shown at 1302, for a given time period (e.g., between 12:00:00 to 12:05:00), the UE RACH probabilities for SSB beams 1, 2, 3, 4 of a base station (e.g., the base station 1202) may correspond to {0.03, 0.7, 0.25, 0.02}, respectively.

In one example, as shown at 1304 and 1306, if the base station is configured with a uniform periodicity for transmitting SSBs via all SSB beams in a cell (e.g., transmitting all SSBs in a full SSB set with the same SSB transmission periodicity), a maximum cell search latency for a UE may correspond to the configured SSB transmission periodicity. For example, as shown at 1304, if the base station is configured to transmit SSBs at every 80 ms via all SSB beams in a cell, the maximum cell search latency for a UE may be 80 ms. Similarly, as shown at 1306, if the base station is configured to transmit SSBs at every 40 ms via all SSB beams in a cell, the maximum cell search latency for a UE may be 40 ms. On the other hand, as shown at 1308, if the base station is configured to transmit SSBs via SSB beams 1, 2, 3, 4 with different periodicities {160, 40, 80, 160} ms, respectively, (e.g., configured based on the UE RACH probabilities {0.03, 0.7, 0.25, 0.02} as described in connection with FIG. 11) in a cell, an average maximum cell search latency for a UE may be 58 ms (e.g., 160×0.03+40×0.7+80×0.25+160×0.03=58).

While the example shown at 1306 provides the lowest cell search latency for a UE, the base station is likely to consume more power compare to the examples shown at 1304 and 1308 as the base station is specified to transmit SSBs every 40 ms via all SSB beams (e.g., a total of 16 SSBs are transmitted over 160 ms). On the other hand, while the example shown at 1304 may achieve better energy saving compared to the example shown at 1306 (e.g., a total of 8 SSBs are transmitted over 160 ms), the maximum cell search latency for a UE may also be increased as a tradeoff (e.g., increased from 40 ms to 80 ms). However, as shown at 1308, by configuring different SSB beams with different SSB transmission periodicities (or irregular SSB patterns) based on UE RACH probabilities, the base station may achieve energy saving (e.g., a total of 8 SSBs are transmitted over 160 ms) without significant impact to the cell search latency. For example, the example at 1308 shows a total of eight SSBs are transmitted within 160 ms with a maximum cell search latency of 58 ms, which is much lower compared to the example shown at 1304 where eight SSBs are also transmitted within 160 ms but with a maximum cell search latency of 80 ms.

Referring back to FIG. 11, in some examples, after the base station 1102 configures SSBs or SSB beams with their corresponding SSB transmission periodicities, at 1114, the base station 1102 may indicate (e.g., broadcast) the configured SSB transmission periodicities and/or beam patterns (e.g., configured SSB beam burst pattern) to UEs. In one aspect, the base station may indicate the configured SSB transmission periodicities and/or beam patterns via SIB1 (i.e., RMSI), which may include a larger signaling overhead for the SIB1. In another example, the base station 1102 may indicate the configured SSB transmission periodicities and/or beam patterns for a portion/set of SSBs by SIB1, and indicate the configured SSB transmission periodicities and/or beam patterns for another portion/set of SSBs by other SIBs (OSI), such as shown by FIG. 6. For example, as shown by FIG. 12, the base station 1102 may indicate SSBs with a longer periodicity via SIB 1 (e.g., SSBs 1, 4 with 160 ms periodicity), and SSBs with a shorter periodicity via OSI (e.g., SSB 2 with 40 ms periodicity and/or SSB 3 with 80 ms periodicity). In some examples, the SIB 1 message transmitted from each SSB beam may include its corresponding SSB transmission periodicity and/or beam pattern configuration and may exclude other SSB beams' SSB transmission periodicities and/or beam patterns (e.g., a dedicated SIB 1 message for each SSB beam). In other examples, the SIB 1 message transmitted from each SSB beam may include all SSB beams SSB transmission periodicities and/or beam patterns (e.g., a common SIB 1 message via all SSB beams). After the UE 1104 and/or the UE 1106 receives the configured SSB transmission periodicities and/or beam patterns for the SSBs, the UE 1104 and/or the UE 1106 may receive or monitor the SSBs from the base station 1102 based on the configured SSB transmission periodicities and/or beam patterns.

In another aspect of the present disclosure, when a set of SSBs are configured with different SSB transmission periodicities, a UE may be configured with different behaviors for monitoring the control resource set zero (CORESET #0) that is associated with the set of SSBs. For purposes of the present disclosure, an SSB set that is transmitted with different SSB transmission periodicities from different SSB beams may be referred to as an “irregular SSB pattern” or an “irregular SSB beam pattern,” whereas an SSB set that is transmitted with a uniform SSB transmission periodicity across all SSB beams may be referred to as a “regular SSB pattern,” or a “regular SSB beam pattern.” In one example, when SSBs from a base station are transmitted based on an irregular SSB pattern, a UE may monitor the associated CORESET #0s as SSBs transmitted based on a regular SSB pattern (e.g., as shown by examples at 1304 and 1306 of FIG. 13). For example, when the UE detects an SSB that is associated with an irregular SSB pattern, the UE may monitor the CORESET #0 the same way as monitoring the CORESET #0 for an SSB that is associated with a regular SSB pattern. In such an example, the UE may be configured to assume that the SSB is a carrier-defining SSB (CD-SSB), which may be associated with CORESET #0 monitoring for SIB.

In another example, when a UE detects an SSB that is associated with an irregular SSB pattern, a UE may be configured not to monitor CORESET #0, where the UE may be configured to assume that the associated CORESET #0s do not exist (e.g., similar to detecting a non-CD-SSB). In such an example, the base station may indicate to the UE regarding the non-association of the CORESET #0 monitoring (e.g., not to monitor for CORESET #0 if such an SSB is detected) via a previously reserved bit in MIB/PBCH.

Each SSB transmitted from a base station may be associated with a plurality of RACH occasions (ROs), where each RO may indicate time and frequency resources for which a UE may use for transmitting preamble message during a RACH procedure (e.g., for sending a PRACH). For example, a UE may transmit a preamble message within a configurable subset of RACH slots that may repeat itself every RACH configuration period within a cell. In some examples, the RACH periodicity for RACH slots may be configured between 10 to 160 ms. Within each RACH Slot, there may be a number of ROs which specifies how many different resources there are for each RACH slot. The time and/or frequency resources of ROs may be configured via SIB 1. In some examples, when the SSBs are associated with different SSB beams, a UE may select an SSB beam and send PRACH using that beam. Then, a base station may determine which SSB beam the UE has selected based on a mapping between SSBs and ROs. For example, by detecting which RO the UE sends PRACH to, the base station may determine which SSB beam is selected by the UE. After that, the base station may determine a beam for subsequent DL transmission with the UE during RACH based on knowing the SSB beam used by the UE. In one example, the mapping between SSBs and ROs may be defined by two RRC parameters msg1-FDM and ssb-perRACH-OccasionAndCB-PreamblesPerSSB. The msg-FDM parameter may specify how many ROs are allocated in frequency domain (at the same location in time domain). The ssb-perRACH-OccasionAndCB-PreamblesPerSSB may specify how many SSBs may be mapped to one RO and how many preamble index may be mapped to single SSB, etc. The mapping between SSBs and ROs may be based on frequency-first, then in time-domain within a slot, and then across RACH slots.

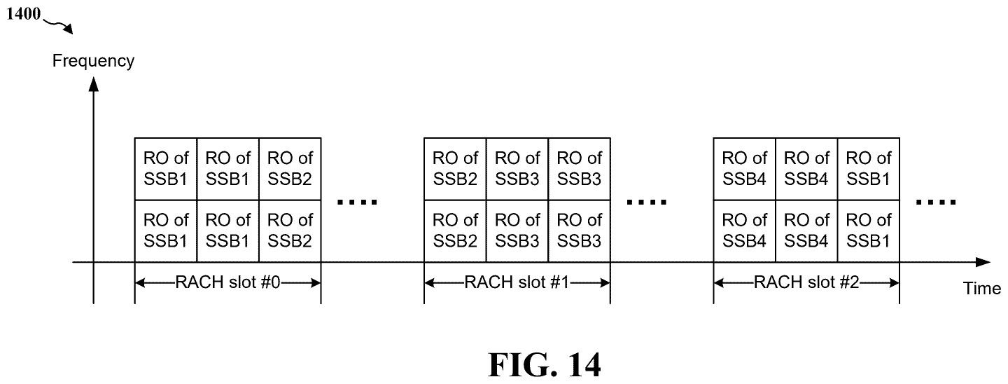

FIG. 14 is a diagram 1400 illustrating an example mapping between SSBs and ROs in accordance with various aspects of the present disclosure. In one example, the mapping of SSBs to ROs may be based on the following mapping logic: (1) first, in an increasing order of preamble indexes within a single PRACH occasion; (2) second, in an increasing order of frequency resource indexes for frequency multiplexed PRACH occasions; (3) third, in an increasing order of time resource indexes for time multiplexed PRACH occasions within a PRACH slot; and (4) in an increasing order of indexes for PRACH slots.

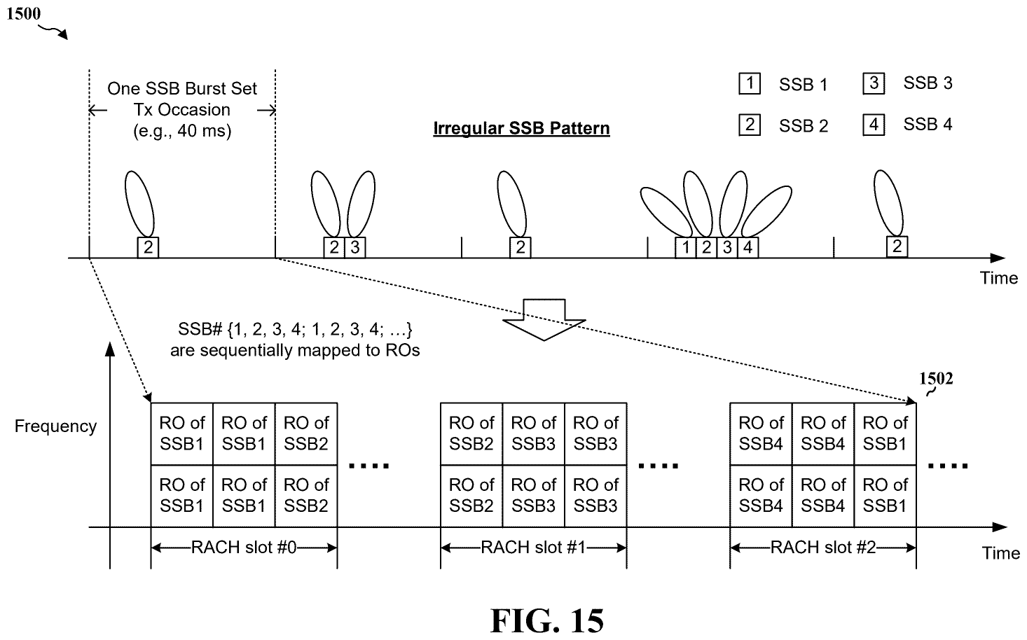

FIG. 15 is a diagram 1500 illustrating an example mapping between SSBs and ROs for an irregular SSB pattern in accordance with various aspects of the present disclosure. In one aspect of the present disclosure, when a base station is configured to transmit SSBs with an irregular SSB pattern (e.g., SSBs in a full SSB set are transmitted with different SSB transmission periodicities), the base station may sequentially map the SSBs in a full SSB set to ROs. For example, SSB #{1, 2, 3, 4; 1, 2, 3, 4; . . . } may be sequentially mapped to ROs for each SSB burst set transmission occasion as shown at 1502, where SSBs not being transmitted (or SSB beams not used for transmitting SSBs) in an SSB burst set transmission occasion may still get mapped to ROs. Such configuration may enable the base station to keep a same number of ROs for each SSB burst set transmission occasion. However, the SSBs and the ROs may have an unequal density, which may result in a different number of per-SSB occasion ROs. For example, each of SSBs #1, 2, 3, 4 is being mapped to same number of ROs regardless of their SSB transmission periodicities.

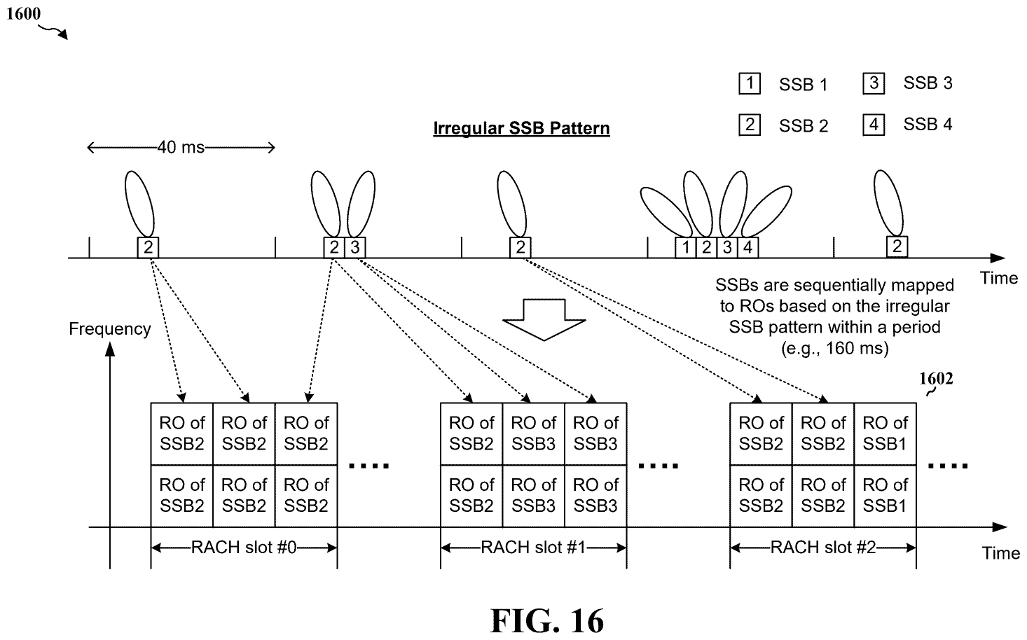

FIG. 16 is a diagram 1600 illustrating an example mapping between SSBs and ROs for an irregular SSB pattern in accordance with various aspects of the present disclosure. In another aspect of the present disclosure, when a base station is configured to transmit SSBs with an irregular SSB pattern, the base station may sequentially map the irregular SSB patterns within the periodicity of a full SSB set. For example, SSB #{2, 2, 3, 2, 1, 2, 3, 4; 2, 2, 3, 2, . . . } may be mapped to ROs within 160 ms, such as shown at 1602, where SSBs not being transmitted in an SSB burst set transmission occasion may not get mapped to ROs. Such configuration may provide a more even number of per-SSB ROs, which may result in the number of per-SSB occasion ROs same for different SSBs. For example, SSB #2 within a period of 160 ms may have 4 times of number of ROs compared to SSB #1 (e.g., SSB #2 is being mapped to four sets of ROs and SSB #1 is being mapped to one set of ROs in the example transmission pattern SSB #{2, 2, 3, 2, 1, 2, 3, 4}).

In another aspect of the present disclosure, when a base station is configured to transmit SSBs with an irregular SSB pattern, for an SSB burst set transmission occasion in which some SSBs are not transmitted, the base station may release the resources for the SSBs not transmitted and use the release resources for other types of communications.

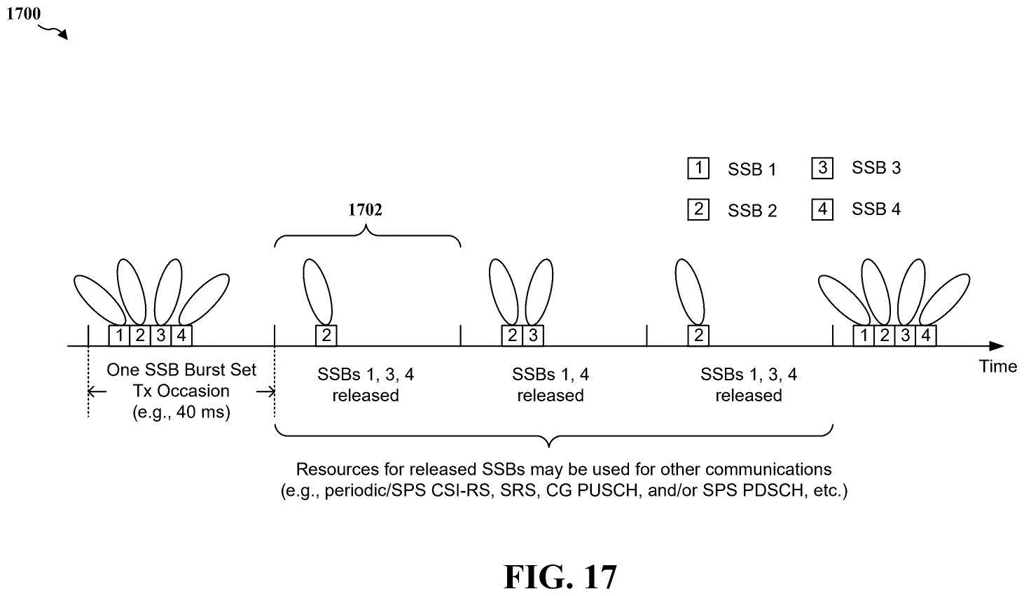

FIG. 17 is a diagram 1700 illustrating an example of using released SSBs for other communications in accordance with various aspects of the present disclosure. As shown at 1702, in one SSB burst set transmission occasion, a base station may be configured to transmit an SSB via a second SSB beam (SSB beam 2), and the other SSB beams (e.g., SSB beams 1, 3, 4) may be configured not to transmit any SSBs. For purposes of the present disclosure, an SSB that is not transmitted in one SSB burst set transmission occasion (e.g., not transmitted in a non-full set SSB) may be referred to as a “released SSB.” For examples, SSBs #1, 3, 4 at 1702 may be referred to as released SSBs.

In on example, the base station may utilize resources for the released SSBs for other types of communications. For example, if there are periodic or semi-persistent (SPS) downlink (DL) and/or uplink (UL) transmission(s) configured between a base station and a UE which overlap with SSBs, and if some of the SSBs are indicated as released SSBs (e.g., not being transmitted), the periodic/SPS DL/UL transmission(s) may use resources for the released SSBs to improve network resource utilization. In one example, the UL/DL transmission(s) may include channel state information (CSI)-reference signal (RS) (CSI-RS), a sounding reference signal (SRS), a configured grant (CG) physical uplink shared channel (PUSCH) (CG PUSCH) and/or an SPS physical downlink shared channel (PDSCH), etc. Such configuration may also be beneficial for network energy saving by aggregating the transmission and/or reception (e.g., UL/DL transmissions) of the base station more gathered in time in addition to the benefit of higher resource utility efficiency.

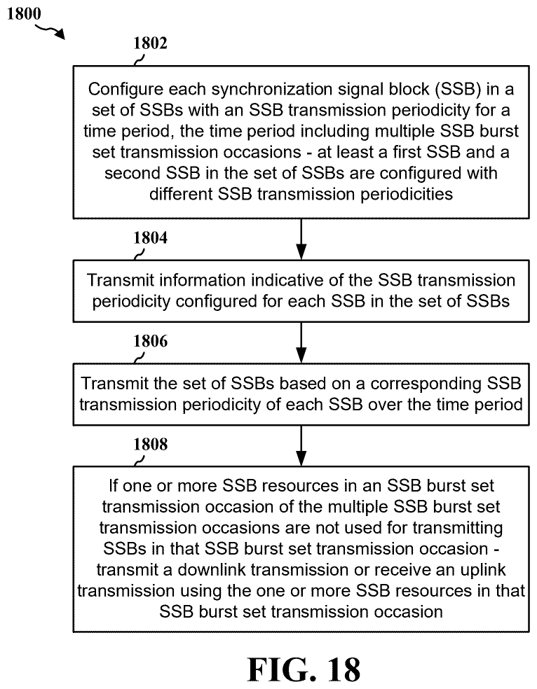

FIG. 18 is a flowchart 1800 of a method of wireless communication. The method may be performed by a base station or a component of a base station (e.g., the base station 102, 180, 310, 1002, 1102, 1202; the apparatus 2002; a processing system, which may include the memory 376 and which may be the entire base station 310 or a component of the base station 310, such as the TX processor 316 the RX processor 370, and/or the controller/processor 375). The method may enable the base station to transmit SSBs in an SSB burst set via multiple transmission beams of the base station, where different SSBs may be transmitted with different SSB transmission periodicities at a given time to achieve energy saving.

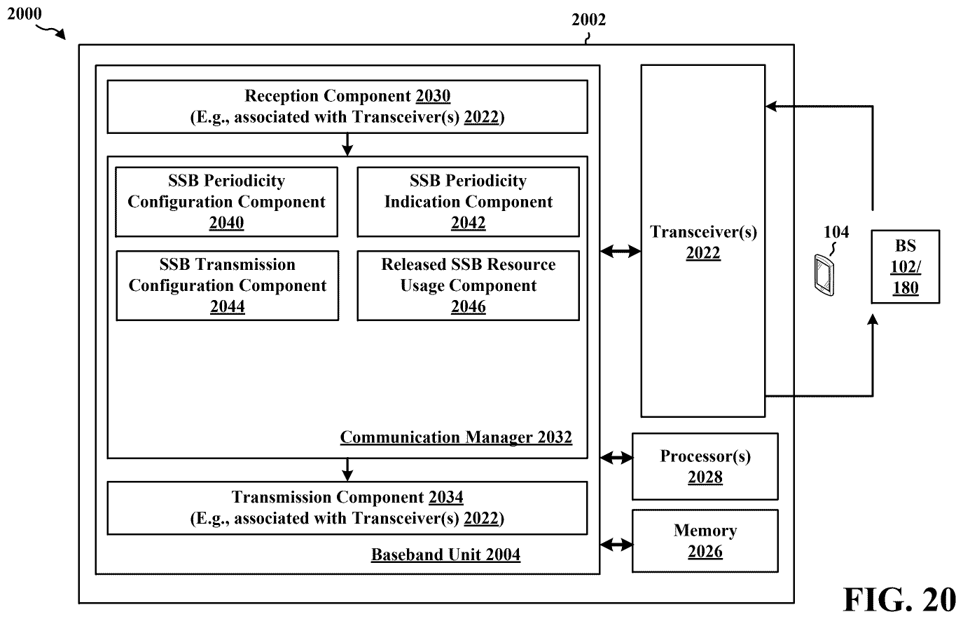

At 1802, the base station may configure each synchronization signal block (SSB) in a set of SSBs with an SSB transmission periodicity for a time period, the time period including multiple SSB burst set transmission occasions, where at least a first SSB and a second SSB in the set of SSBs are configured with different SSB transmission periodicities, such as described in connection with FIGS. 11 and 12. For example, at 1110, the base station 1102 may configure each SSB in a set of SSBs (e.g., SSBs #1 to N) with an SSB transmission periodicity for a time period that includes multiple SSB burst set transmission occasions, where different SSBs in the set of SSBs may be configured with different SSB transmission periodicities. The configuration of the SSB transmission periodicity may be performed by, e.g., the SSB periodicity configuration component 2040 of the apparatus 2002 in FIG. 20.

In one example, to configure each SSB in the set of SSBs with the SSB transmission periodicity for the time period, the base station may configure an SSB transmission pattern for each of the multiple SSB burst set transmission occasions, where at least one of the multiple SSB burst set transmission occasions transmits a subset of the set of SSBs, such as described in connection with 1204 of FIG. 12.

At 1804, the base station may transmit (e.g., to one or more UEs) information indicative of the SSB transmission periodicity configured for each SSB in the set of SSBs, such as described in connection with FIGS. 11 and 12. For example, at 1114, the base station 1102 may transmit, to the UE 1104 and the UE 1106, an indication of the SSB transmission periodicity configured for each SSB in the set of SSBs. The transmission of the information of the SSB transmission periodicity may be performed by, e.g., the SSB periodicity indication component 2042 and/or the transmission component 2034 of the apparatus 2002 in FIG. 20.

In one example, the information may be at least partially transmitted via an SIB 1 message. In such an example, a portion of the information may be transmitted via an OSI message.

At 1806, the base station may transmit the set of SSBs based on a corresponding SSB transmission periodicity of each SSB over the time period, such as described in connection with FIGS. 11 and 12. For example, at 1112, the base station 1102 may transmit a first SSB to the UE 1104 based a first SSB periodicity and transmit a second SSB to the UE 1106 based a second SSB periodicity. The transmission of the SSBs based on different SSB transmission periodicities may be performed by, e.g., the SSB transmission configuration component 2044 and/or the transmission component 2034 of the apparatus 2002 in FIG. 20.

At 1808, if one or more SSB resources in an SSB burst set transmission occasion of the multiple SSB burst set transmission occasions are not used for transmitting SSBs in that SSB burst set transmission occasion, the base station may transmit a downlink transmission or receive an uplink transmission using the one or more SSB resources in that SSB burst set transmission occasion, such as described in connection with FIG. 17. For example, at 1324, a base station may transmit or receive periodic/SPS CSI-RS, SRS, CG PUSCH, and/or SPS PDSCH, etc., using one or more released SSB resources. The transmission or reception using one or more SSB resources may be performed by, e.g., the released SSB resource usage component 2046, the reception component 2030, and/or the transmission component 2034 of the apparatus 2002 in FIG. 20. In such an example, the downlink transmission or the uplink transmission may be periodic or semi-persistent. In such an example, the downlink transmission or the uplink transmission includes at least one of: a CSI-RS, an SRS, a CG PUSCH, or an SPS PDSCH.

In one example, the base station may transmit, to one or more UEs, an indication not to monitor for a CORESET #0 in an SSB burst set transmission occasion of the multiple SSB burst set transmission occasions if the SSB burst set transmission occasion transmits a subset of the set of SSBs.

In another example, the base station may sequentially map SSBs transmitted in each of the multiple SSB burst set transmission occasions to a same number of RACH occasions, such as described in connection with FIG. 16.

In another example, the base station may sequentially map each SSB in the full set of SSBs to a same number of RACH occasions for each of the multiple SSB burst set transmission occasions, such as described in connection with FIG. 15.

In another example, each SSB in the full set of SSBs may be transmitted via a corresponding SSB beam, and SSB transmission periodicity configured for each SSB in the full set of SSBs may be based at least in part on a probability or statistic associated with a number of UEs communicating with the base station via the corresponding SSB beam during the time period, such as described in connection with FIG. 10. In such an example, the probability or the statistic associated with the number of UEs communicating with the base station via the corresponding SSB beam during the time period may include the number of UEs performing RACH procedures with the base station via the corresponding SSB beam during the time period.

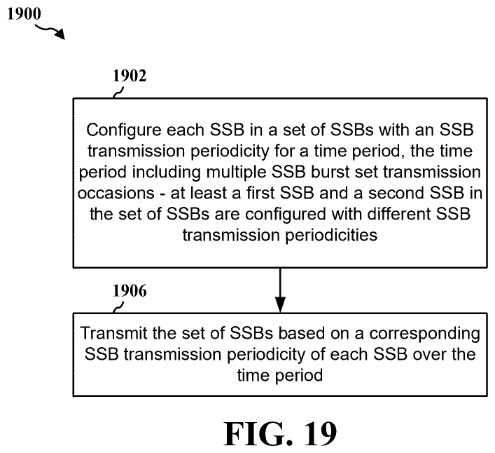

FIG. 19 is a flowchart 1900 of a method of wireless communication. The method may be performed by a base station or a component of a base station (e.g., the base station 102, 180, 310, 1002, 1102, 1202; the apparatus 2002; a processing system, which may include the memory 376 and which may be the entire base station 310 or a component of the base station 310, such as the TX processor 316 the RX processor 370, and/or the controller/processor 375). The method may enable the base station to transmit SSBs in an SSB burst set via multiple transmission beams of the base station, where different SSBs may be transmitted with different SSB transmission periodicities at a given time to achieve energy saving.

At 1902, the base station may configure each synchronization signal block (SSB) in a full set of SSBs with an SSB transmission periodicity for a time period, the time period including multiple SSB burst set transmission occasions, where at least a first SSB and a second SSB in the full set of SSBs are configured with different SSB transmission periodicities, such as described in connection with FIGS. 11 and 12. For example, at 1110, the base station 1102 may configure each SSB in a full set of SSBs (e.g., SSBs #1 to N) with an SSB transmission periodicity for a time period that includes multiple SSB burst set transmission occasions, where different SSBs in the full set of SSBs may be configured with different SSB transmission periodicities. The configuration of the SSB transmission periodicity may be performed by, e.g., the SSB periodicity configuration component 2040 of the apparatus 2002 in FIG. 20.

In one example, to configure each SSB in the full set of SSBs with the SSB transmission periodicity for the time period, the base station may configure an SSB transmission pattern for each of the multiple SSB burst set transmission occasions, where at least one of the multiple SSB burst set transmission occasions transmits a subset of the set of SSBs, such as described in connection with 1204 of FIG. 12.

In another example, the base station may transmit, to one or more UEs, information indicative of the SSB transmission periodicity configured for each SSB in the full set of SSBs, such as described in connection with FIGS. 11 and 12. For example, at 1114, the base station 1102 may transmit, to the UE 1104 and the UE 1106, an indication of the SSB transmission periodicity configured for each SSB in the full set of SSBs. The transmission of the information of the SSB transmission periodicity may be performed by, e.g., the SSB periodicity indication component 2042 and/or the transmission component 2034 of the apparatus 2002 in FIG. 20.

In another example, the information may be at least partially transmitted via an SIB 1 message. In such an example, a portion of the information may be transmitted via an OSI message.

At 1906, the base station may transmit the full set of SSBs based on a corresponding SSB transmission periodicity of each SSB over the time period, such as described in connection with FIGS. 11 and 12. For example, at 1112, the base station 1102 may transmit a first SSB to the UE 1104 based a first SSB periodicity and transmit a second SSB to the UE 1106 based a second SSB periodicity. The transmission of the SSBs based on different SSB transmission periodicities may be performed by, e.g., the SSB transmission configuration component 2044 and/or the transmission component 2034 of the apparatus 2002 in FIG. 20.

In one example, if one or more SSB resources in an SSB burst set transmission occasion of the multiple SSB burst set transmission occasions are not used for transmitting SSBs in that SSB burst set transmission occasion, the base station may transmit a downlink transmission or receive an uplink transmission using the one or more SSB resources in that SSB burst set transmission occasion, such as described in connection with FIG. 17. For example, at 1324, a base station may transmit or receive periodic/SPS CSI-RS, SRS, CG PUSCH, and/or SPS PDSCH, etc., using one or more released SSB resources. The transmission or reception using one or more SSB resources may be performed by, e.g., the released SSB resource usage component 2046, the reception component 2030, and/or the transmission component 2034 of the apparatus 2002 in FIG. 20. In such an example, the downlink transmission or the uplink transmission may be periodic or semi-persistent. In such an example, the downlink transmission or the uplink transmission includes at least one of: a CSI-RS, an SRS, a CG PUSCH, or an SPS PDSCH.

In another example, the base station may transmit, to one or more UEs, an indication not to monitor for a CORESET #0 in an SSB burst set transmission occasion of the multiple SSB burst set transmission occasions if the SSB burst set transmission occasion transmits a subset of the set of SSBs.

In another example, the base station may sequentially map SSBs transmitted in each of the multiple SSB burst set transmission occasions to a same number of RACH occasions, such as described in connection with FIG. 16.

In another example, the base station may sequentially map each SSB in the full set of SSBs to a same number of RACH occasions for each of the multiple SSB burst set transmission occasions, such as described in connection with FIG. 15.

In another example, each SSB in the full set of SSBs may be transmitted via a corresponding SSB beam, and SSB transmission periodicity configured for each SSB in the full set of SSBs may be based at least in part on a probability or statistic associated with a number of UEs communicating with the base station via the corresponding SSB beam during the time period, such as described in connection with FIG. 10. In such an example, the probability or the statistic associated with the number of UEs communicating with the base station via the corresponding SSB beam during the time period may include the number of UEs performing RACH procedures with the base station via the corresponding SSB beam during the time period.

FIG. 20 is a diagram 2000 illustrating an example of a hardware implementation for an apparatus 2002. The apparatus 2002 may be a base station, a component of a base station, or may implement base station functionality. In some aspects, the apparatus 2002 may include a baseband unit 2004. The baseband unit 2004 may communicate through at least one transceiver 2022 (e.g., one or more RF transceivers and/or antennas) with the UE 104. The at least one transceiver 2022 may be associated with or include a reception component 2030 and/or a transmission component 2034. The baseband unit 2004 may include a computer-readable medium/memory (e.g., a memory 2026). The baseband unit 2004 and/or the at least one processor 2028 may be responsible for general processing, including the execution of software stored on the computer-readable medium/memory. The software, when executed by the baseband unit 2004 and/or the at least one processor 2028, causes the baseband unit 2004 and/or the at least one processor 2028 to perform the various functions described supra. The computer-readable medium/memory may also be used for storing data that is manipulated by the baseband unit 2004 when executing software. The baseband unit 2004 further includes the reception component 2030, a communication manager 2032, and the transmission component 2034. The reception component 2030 and the transmission component 2034 may, in a non-limiting example, include at least one transceiver and/or at least one antenna subsystem. The communication manager 2032 includes the one or more illustrated components. The components within the communication manager 2032 may be stored in the computer-readable medium/memory and/or configured as hardware within the baseband unit 2004. The baseband unit 2004 may be a component of the RF sensing node and may include the memory 376 and/or at least one of the TX processor 316, the RX processor 370, and the controller/processor 375.

The communication manager 2032 includes an SSB periodicity configuration component 2040 that configures each SSB in a full set of SSBs with an SSB transmission periodicity for a time period, the time period including multiple SSB burst set transmission occasions, where at least a first SSB and a second SSB in the full set of SSBs are configured with different SSB transmission periodicities, e.g., as described in connection with 1802 of FIGS. 18 and/or 1902 of FIG. 19. The communication manager 2032 further includes an SSB periodicity indication component 2042 that transmits, to one or more UEs, information indicative of the SSB transmission periodicity configured for each SSB in the full set of SSBs, e.g., as described in connection with 1804 of FIG. 18. The communication manager 2032 further includes an SSB transmission configuration component 2044 that transmits the full set of SSBs based on a corresponding SSB transmission periodicity of each SSB over the time per, e.g., as described in connection with 1806 of FIGS. 18 and/or 1906 of FIG. 19. The communication manager 2032 further includes a released SSB resource usage component 2046 that transmits a downlink transmission or receive an uplink transmission using the one or more SSB resources in an SSB burst set transmission occasion, e.g., as described in connection with 1808 of FIG. 18.

The apparatus may include additional components that perform each of the blocks of the algorithm in the flowcharts of FIGS. 18 and 19. As such, each block in the flowcharts of FIGS. 18 and 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the baseband unit 2004, includes means for configuring each SSB in a full set of SSBs with an SSB transmission periodicity for a time period, the time period including multiple SSB burst set transmission occasions, where at least a first SSB and a second SSB in the full set of SSBs are configured with different SSB transmission periodicities (e.g., the SSB periodicity configuration component 2040). The apparatus 2002 includes means for transmitting, to one or more UEs, information indicative of the SSB transmission periodicity configured for each SSB in the full set of SSBs (e.g., the SSB periodicity indication component 2042 and/or the transmission component 2034). The apparatus 2002 includes means for transmitting the full set of SSBs based on a corresponding SSB transmission periodicity of each SSB over the time period (e.g., the SSB transmission configuration component 2044 and/or the transmission component 2034). The apparatus 2002 includes means for transmitting a downlink transmission or receive an uplink transmission using the one or more SSB resources in an SSB burst set transmission occasion (e.g., the released SSB resource usage component 2046, the reception component 2030, and/or the transmission component 2034).

In one configuration, to configure each SSB in the full set of SSBs with the SSB transmission periodicity for the time period, the base station may configure an SSB transmission pattern for each of the multiple SSB burst set transmission occasions, where at least one of the multiple SSB burst set transmission occasions transmits a subset of the set of SSBs, such as described in connection with 1204 of FIG. 12.

In another configuration, the information may be at least partially transmitted via an SIB 1 message. In such a configuration, a portion of the information may be transmitted via an OSI message.

In another configuration, the apparatus 2002 includes means for transmitting, to one or more UEs, an indication not to monitor for a CORESET #0 in an SSB burst set transmission occasion of the multiple SSB burst set transmission occasions if the SSB burst set transmission occasion transmits a subset of the set of SSBs.

In another configuration, the apparatus 2002 includes means for sequentially mapping SSBs transmitted in each of the multiple SSB burst set transmission occasions to a same number of RACH occasions, such as described in connection with FIG. 16.

In another configuration, the apparatus 2002 includes means for sequentially mapping each SSB in the full set of SSBs to a same number of RACH occasions for each of the multiple SSB burst set transmission occasions, such as described in connection with FIG. 15.

In another configuration, each SSB in the full set of SSBs may be transmitted via a corresponding SSB beam, and SSB transmission periodicity configured for each SSB in the full set of SSBs may be based at least in part on a probability or statistic associated with a number of UEs communicating with the base station via the corresponding SSB beam during the time period, such as described in connection with FIG. 10. In such a configuration, the probability or the statistic associated with the number of UEs communicating with the base station via the corresponding SSB beam during the time period may include the number of UEs performing RACH procedures with the base station via the corresponding SSB beam during the time period.

The means may be one or more of the components of the apparatus 2002 configured to perform the functions recited by the means. As described supra, the apparatus 2002 may include the TX Processor 316, the RX Processor 370, and the controller/processor 375. As such, in one configuration, the means may be the TX Processor 316, the RX Processor 370, and the controller/processor 375 configured to perform the functions recited by the means.

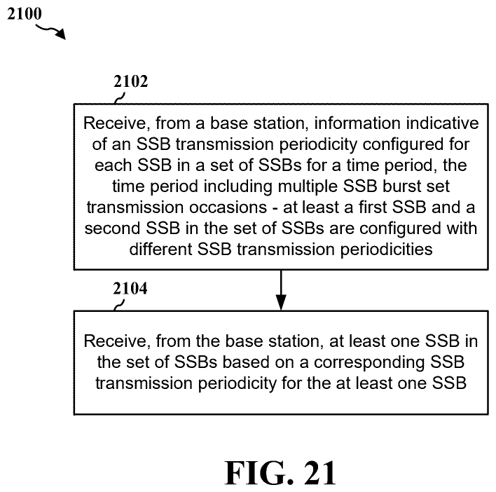

FIG. 21 is a flowchart 2100 of a method of wireless communication. The method may be performed by a UE or a component of a UE (e.g., the UE 104, 350, 1104, 1106; the apparatus 2202; a processing system, which may include the memory 360 and which may be the entire UE 350 or a component of the UE 350, such as the TX processor 368, the RX processor 356, and/or the controller/processor 359). The method may enable the UE to receive or monitor different SSBs from a base station based on different periodicities.

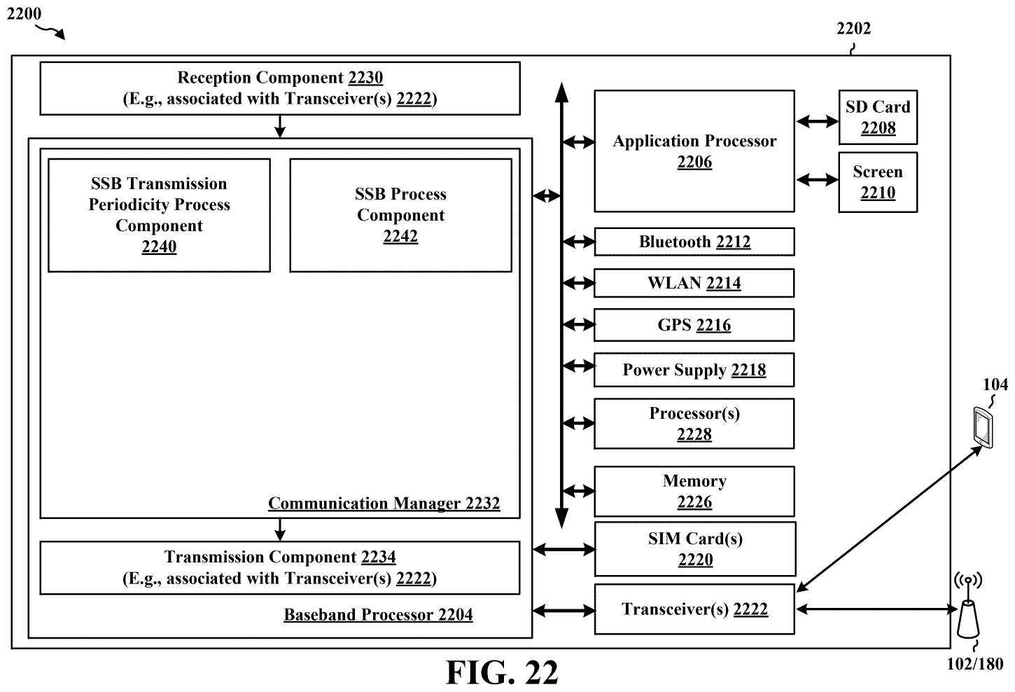

At 2102, the UE may receive, from a base station, information indicative of an SSB transmission periodicity configured for each SSB in a full set of SSBs for a time period, the time period including multiple SSB burst set transmission occasions, where at least a first SSB and a second SSB in the full set of SSBs are configured with different SSB transmission periodicities, such as described in connection with FIGS. 11 and 12. For example, at 1114, the UE 1104 may receive, from the base station 1102, an indication of an SSB transmission periodicity configured for each SSB in a full set of SSBs for a time period that includes multiple SSB burst set transmission occasions, where at least a first SSB and a second SSB in the full set of SSBs may be configured with different SSB transmission periodicities. The reception of the information of the SSB transmission periodicity may be performed by, e.g., the SSB transmission periodicity process component 2240 and/or the reception component 2230 of the apparatus 2202 in FIG. 22.

At 2104, the UE may receive, from the base station, at least one SSB in the full set of SSBs based a corresponding SSB transmission periodicity for the at least one SSB, such as described in connection with FIGS. 11 and 12. For example, at 1112, the UE 1104 may receive, from the base station 1102, a first SSB in the full set of SSBs based a first SSB transmission periodicity. The reception of the SSB based on the corresponding SSB transmission periodicity may be performed by, e.g., the SSB process component 2242 and/or the reception component 2230 of the apparatus 2202 in FIG. 22.

In one example, at least one of the multiple SSB burst set transmission occasions may not transmit the full set of SSBs.

In another example, if one or more SSB resources in an SSB burst set transmission occasion of the multiple SSB burst set transmission occasions are not used for transmitting SSBs in that SSB burst set transmission occasion, the UE may receive a downlink transmission or transmit an uplink transmission using the one or more SSB resources in that SSB burst set transmission occasion. In such an example, the downlink transmission or the uplink transmission may be periodic or semi-persistent. In such an example, the downlink transmission or the uplink transmission may include at least one of: a CSI-RS, an SRS, a CG PUSCH, or an SPS PDSCH.

In another example, the information may be at least partially received via an SIB 1 message. In such an example, a portion of the information is received via an OSI message.

In another example, the UE may receive, from the base station, an indication not to monitor for a CORESET #0 in an SSB burst set transmission occasion of the multiple SSB burst set transmission occasions if the SSB burst set transmission occasion transmits a subset of the set of SSBs, and the UE may skip monitoring the CORESET #0 for one or more SSB burst set transmission occasions that do not transmit the full set of SSBs.

In another example, each SSB in the full set of SSBs may be transmitted via a corresponding SSB beam of the base station, and the SSB transmission periodicity configured for each SSB in the full set of SSBs may be based at least in part on a probability or statistic associated with a number of UEs communicating with the base station via the corresponding SSB beam during the time period. In such an example, the probability or the statistic associated with the number of UEs communicating with the base station via the corresponding SSB beam during the time period may include the number of UEs performing RACH procedures with the base station via the corresponding SSB beam during the time period.

FIG. 22 is a diagram 2200 illustrating an example of a hardware implementation for an apparatus 2202. The apparatus 2202 may be a UE, a component of a UE, or may implement UE functionality. In some aspects, the apparatus 2202 may include a baseband processor 2204 (also referred to as a modem) coupled to at least one transceiver 2222 (e.g., one or more RF transceivers and/or antennas). The at least one transceiver 2222 may be associated with or include a reception component 2230 and/or a transmission component 2234. In some aspects, the apparatus 2202 may further include one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, or a power supply 2218. The baseband processor 2204 communicates through the at least one transceiver 2222 with the BS 102/180. The baseband processor 2204 may include a computer-readable medium/memory (e.g., a memory 2226). The computer-readable medium/memory may be non-transitory. The baseband processor 2204 and/or at least one processor 2228 is responsible for general processing, including the execution of software stored on the computer-readable medium/memory. The software, when executed by the baseband processor 2204 and/or the at least one processor 2228, causes the baseband processor 2204 and/or the at least one processor 2228 to perform the various functions described supra. The computer-readable medium/memory may also be used for storing data that is manipulated by the baseband processor 2204 when executing software. The baseband processor 2204 further includes the reception component 2230, a communication manager 2232, and the transmission component 2234. The reception component 2230 and the transmission component 2234 may, in a non-limiting example, include at least one transceiver and/or at least one antenna subsystem. The communication manager 2232 includes the one or more illustrated components. The components within the communication manager 2232 may be stored in the computer-readable medium/memory and/or configured as hardware within the baseband processor 2204. The baseband processor 2204 may be a component of the UE 350 and may include the memory 360 and/or at least one of the TX processor 368, the RX processor 356, and the controller/processor 359. In one configuration, the apparatus 2202 may be a modem chip and include just the baseband processor 2204, and in another configuration, the apparatus 2202 may be the entire UE (e.g., see 350 of FIG. 3) and include the additional modules of the apparatus 2202.

The communication manager 2232 includes an SSB transmission periodicity process component 2240 that is configured to receive, from a base station, information indicative of an SSB transmission periodicity configured for each SSB in a full set of SSBs for a time period, the time period including multiple SSB burst set transmission occasions, where at least a first SSB and a second SSB in the full set of SSBs are configured with different SSB transmission periodicities, e.g., as described in connection with 2102 of FIG. 21. The communication manager 2232 further includes an SSB process component 2242 that is configured to receive, from the base station, at least one SSB in the full set of SSBs based a corresponding SSB transmission periodicity for the at least one SSB, e.g., as described in connection with 2104 of FIG. 21.

The apparatus may include additional components that perform each of the blocks of the algorithm in the flowchart of FIG. 21. As such, each block in the flowchart of FIG. 21 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the baseband processor 2204, includes means for receiving, from a base station, information indicative of an SSB transmission periodicity configured for each SSB in a full set of SSBs for a time period, the time period including multiple SSB burst set transmission occasions, where at least a first SSB and a second SSB in the full set of SSBs are configured with different SSB transmission periodicities (e.g., the SSB transmission periodicity process component 2240 and/or the reception component 2230). The apparatus 2202 includes means for receiving, from the base station, at least one SSB in the full set of SSBs based a corresponding SSB transmission periodicity for the at least one SSB (e.g., the SSB process component 2242 and/or the reception component 2230).

In one configuration, at least one of the multiple SSB burst set transmission occasions may not transmit the full set of SSBs.

In another configuration, if one or more SSB resources in an SSB burst set transmission occasion of the multiple SSB burst set transmission occasions are not used for transmitting SSBs in that SSB burst set transmission occasion, the apparatus 2202 includes means for receiving a downlink transmission or transmit an uplink transmission using the one or more SSB resources in that SSB burst set transmission occasion. In such a configuration, the downlink transmission or the uplink transmission may be periodic or semi-persistent. In such a configuration, the downlink transmission or the uplink transmission may include at least one of: a CSI-RS, an SRS, a CG PUSCH, or an SPS PDSCH.

In another configuration, the information may be at least partially received via an SIB 1 message. In such a configuration, a portion of the information is received via an OSI message.

In another configuration, the apparatus 2202 includes means for receiving, from the base station, an indication not to monitor for a CORESET #0 in an SSB burst set transmission occasion of the multiple SSB burst set transmission occasions if the SSB burst set transmission occasion transmits a subset of the set of SSBs, and means for skipping monitoring the CORESET #0 for one or more SSB burst set transmission occasions that do not transmit the full set of SSBs.

In another configuration, each SSB in the full set of SSBs may be transmitted via a corresponding SSB beam of the base station, and the SSB transmission periodicity configured for each SSB in the full set of SSBs may be based at least in part on a probability or statistic associated with a number of UEs communicating with the base station via the corresponding SSB beam during the time period. In such a configuration, the probability or the statistic associated with the number of UEs communicating with the base station via the corresponding SSB beam during the time period may include the number of UEs performing RACH procedures with the base station via the corresponding SSB beam during the time period.

The means may be one or more of the components of the apparatus 2202 configured to perform the functions recited by the means. As described supra, the apparatus 2202 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to configure each SSB in a full set of SSBs with an SSB transmission periodicity for a time period, the time period including multiple SSB burst set transmission occasions, where at least a first SSB and a second SSB in the full set of SSBs are configured with different SSB transmission periodicities; and transmit the full set of SSBs based on a corresponding SSB transmission periodicity of each SSB over the time period.

Aspect 2 is the apparatus of aspect 1, where to configure each SSB in the full set of SSBs with the SSB transmission periodicity for the time period, the at least one processor is further configured to: configure an SSB transmission pattern for each of the multiple SSB burst set transmission occasions, where at least one of the multiple SSB burst set transmission occasions transmits a subset of the set of SSBs.

Aspect 3 is the apparatus of any of aspects 1 and 2, where if one or more SSB resources in an SSB burst set transmission occasion of the multiple SSB burst set transmission occasions are not used for transmitting SSBs in that SSB burst set transmission occasion, the at least one processor is further configured to: transmit a downlink transmission or receive an uplink transmission using the one or more SSB resources in that SSB burst set transmission occasion.

Aspect 4 is the apparatus of any of aspects 1 to 3, where the downlink transmission or the uplink transmission is periodic or semi-persistent.

Aspect 5 is the apparatus of any of aspects 1 to 4, where the downlink transmission or the uplink transmission includes at least one of: a CSI-RS, an SRS, a CG PUSCH, or an SPS PDSCH.

Aspect 6 is the apparatus of any of aspects 1 to 5, where the at least one processor is further configured to: transmit, to one or more UEs, information indicative of the SSB transmission periodicity configured for each SSB in the full set of SSBs.

Aspect 7 is the apparatus of any of aspects 1 to 6, where the information is at least partially transmitted via an SIB 1 message.

Aspect 8 is the apparatus of any of aspects 1 to 7, where a portion of the information is transmitted via an OSI message.

Aspect 9 is the apparatus of any of aspects 1 to 8, where the at least one processor is further configured to: transmit, to one or more UEs, an indication not to monitor for a CORESET #0 in an SSB burst set transmission occasion of the multiple SSB burst set transmission occasions if the SSB burst set transmission occasion transmits a subset of the set of SSBs.

Aspect 10 is the apparatus of any of aspects 1 to 9, where the at least one processor is further configured to: sequentially map SSBs transmitted in each of the multiple SSB burst set transmission occasions to a same number of RACH occasions.

Aspect 11 is the apparatus of any of aspects 1 to 10, where the at least one processor is further configured to: sequentially map each SSB in the full set of SSBs to a same number of RACH occasions for each of the multiple SSB burst set transmission occasions.

Aspect 12 is the apparatus of any of aspects 1 to 11, where each SSB in the full set of SSBs is transmitted via a corresponding SSB beam, and where the SSB transmission periodicity configured for each SSB in the full set of SSBs is based at least in part on a probability or statistic associated with a number of UEs communicating with the base station via the corresponding SSB beam during the time period.

Aspect 13 is the apparatus of any of aspects 1 to 12, where the probability or the statistic associated with the number of UEs communicating with the base station via the corresponding SSB beam during the time period includes the number of UEs performing RACH procedures with the base station via the corresponding SSB beam during the time period.

Aspect 14 is a method of wireless communication for implementing any of aspects 1 to 13.

Aspect 15 is an apparatus for wireless communication including means for implementing any of aspects 1 to 13.

Aspect 16 is a computer-readable medium storing computer executable code, where the code when executed by a processor causes the processor to implement any of aspects 1 to 13.

Aspect 17 is an apparatus for wireless communication including at least one processor coupled to a memory and configured to receive, from a base station, information indicative of an SSB transmission periodicity configured for each SSB in a full set of SSBs for a time period, the time period including multiple SSB burst set transmission occasions, where at least a first SSB and a second SSB in the full set of SSBs are configured with different SSB transmission periodicities; and receive, from the base station, at least one SSB in the full set of SSBs based a corresponding SSB transmission periodicity for the at least one SSB.

Aspect 18 is the apparatus of aspect 17, where at least one of the multiple SSB burst set transmission occasions transmits a subset of the set of SSBs.

Aspect 19 is the apparatus of any of aspects 17 and 18, where if one or more SSB resources in an SSB burst set transmission occasion of the multiple SSB burst set transmission occasions are not used for transmitting SSBs in that SSB burst set transmission occasion, the at least one processor is further configured to: receive a downlink transmission or transmit an uplink transmission using the one or more SSB resources in that SSB burst set transmission occasion.

Aspect 20 is the apparatus of any of aspects 17 to 19, where the downlink transmission or the uplink transmission is periodic or semi-persistent.

Aspect 21 is the apparatus of any of aspects 17 to 20, where the downlink transmission or the uplink transmission includes at least one of: a CSI-RS, an SRS, a CG PUSCH, or an SPS PDSCH.

Aspect 22 is the apparatus of any of aspects 17 to 21, where the information is at least partially received via a system information block type 1 message.

Aspect 23 is the apparatus of any of aspects 17 to 22, where a portion of the information is received via an other system information message.

Aspect 24 is the apparatus of any of aspects 17 to 23, where the at least one processor is further configured to: receive, from the base station, an indication not to monitor for a CORESET #0 in an SSB burst set transmission occasion of the multiple SSB burst set transmission occasions if the SSB burst set transmission occasion transmits a subset of the set of SSBs; and skip monitoring the CORESET #0 for one or more SSB burst set transmission occasions that do not transmit the full set of SSBs.

Aspect 25 is the apparatus of any of aspects 17 to 24, where each SSB in the full set of SSBs is transmitted via a corresponding SSB beam of the base station, and where the SSB transmission periodicity configured for each SSB in the full set of SSBs is based at least in part on a probability or statistic associated with a number of UEs communicating with the base station via the corresponding SSB beam during the time period.

Aspect 26 is the apparatus of any of aspects 17 to 25, where the probability or the statistic associated with the number of UEs communicating with the base station via the corresponding SSB beam during the time period includes the number of UEs performing RACH procedures with the base station via the corresponding SSB beam during the time period.

Aspect 27 is a method of wireless communication for implementing any of aspects 17 to 26.

Aspect 28 is an apparatus for wireless communication including means for implementing any of aspects 17 to 26.

Aspect 29 is a computer-readable medium storing computer executable code, where the code when executed by a processor causes the processor to implement any of aspects 17 to 26.

What is claimed is:

1. An apparatus for wireless communication at a base station, comprising:
a memory; and
at least one processor coupled to the memory and configured to:
configure each synchronization signal block (SSB) in a set of SSBs with an SSB transmission periodicity for a time period, the time period including multiple SSB burst set transmission occasions, wherein at least a first SSB and a second SSB in the set of SSBs are configured with different SSB transmission periodicities; and
transmit the set of SSBs based on a corresponding SSB transmission periodicity of each SSB over the time period.

2. The apparatus of claim 1, wherein to configure each SSB in the set of SSBs with the SSB transmission periodicity for the time period, the at least one processor is further configured to:
configure an SSB transmission pattern for each of the multiple SSB burst set transmission occasions, wherein at least one of the multiple SSB burst set transmission occasions transmits a subset of the set of SSBs.

3. The apparatus of claim 1, wherein if one or more SSB resources in an SSB burst set transmission occasion of the multiple SSB burst set transmission occasions are not used for transmitting SSBs in that SSB burst set transmission occasion, the at least one processor is further configured to:
transmit a downlink transmission or receive an uplink transmission using the one or more SSB resources in that SSB burst set transmission occasion.

4. The apparatus of claim 3, wherein the downlink transmission or the uplink transmission is periodic or semi-persistent.

5. The apparatus of claim 4, wherein the downlink transmission or the uplink transmission includes at least one of: a channel state information (CSI)-reference signal (RS) (CSI-RS), a sounding reference signal (SRS), a configured grant (CG) physical uplink shared channel (PUSCH), or a semi persistent scheduling (SPS) physical downlink shared channel (PDSCH).

6. The apparatus of claim 1, wherein the at least one processor is further configured to:
transmit information indicative of the SSB transmission periodicity configured for each SSB in the set of SSBs.

7. The apparatus of claim 6, wherein the information is at least partially transmitted via a system information block type 1 (SIB 1) message.

8. The apparatus of claim 7, wherein a portion of the information is transmitted via an other system information (OSI) message.

9. The apparatus of claim 1, wherein the at least one processor is further configured to:
transmit, to one or more UEs, an indication not to monitor for a control resource set #0 (CORESET #0) in an SSB burst set transmission occasion of the multiple SSB burst set transmission occasions if the SSB burst set transmission occasion transmits a subset of the set of SSBs.

10. The apparatus of claim 1, wherein the at least one processor is further configured to:
sequentially map SSBs transmitted in each of the multiple SSB burst set transmission occasions to a same number of random-access channel (RACH) occasions.

11. The apparatus of claim 1, wherein the at least one processor is further configured to:
sequentially map each SSB in the set of SSBs to a same number of random-access channel (RACH) occasions for each of the multiple SSB burst set transmission occasions.

12. The apparatus of claim 1, wherein each SSB in the set of SSBs is transmitted via a corresponding SSB beam, and wherein the SSB transmission periodicity configured for each SSB in the set of SSBs is based at least in part on a probability or statistic associated with a number of user equipments (UEs) communicating with the base station via the corresponding SSB beam during the time period.

13. The apparatus of claim 12, wherein the probability or the statistic associated with the number of UEs communicating with the base station via the corresponding SSB beam during the time period includes the number of UEs performing random-access channel (RACH) procedures with the base station via the corresponding SSB beam during the time period.

14. A method of wireless communication at a base station, comprising:
configuring each synchronization signal block (SSB) in a set of SSBs with an SSB transmission periodicity for a time period, the time period including multiple SSB burst set transmission occasions, wherein at least a first SSB and a second SSB in the set of SSBs are configured with different SSB transmission periodicities; and
transmitting the set of SSBs based on a corresponding SSB transmission periodicity of each SSB over the time period.

15. The method of claim 14, wherein configuring each SSB in the set of SSBs with the SSB transmission periodicity for the time period further comprises:
configuring an SSB transmission pattern for each of the multiple SSB burst set transmission occasions, wherein at least one of the multiple SSB burst set transmission occasions transmits a subset of the set of SSBs.

16. The method of claim 14, wherein if one or more SSB resources in an SSB burst set transmission occasion of the multiple SSB burst set transmission occasions are not used for transmitting SSBs in that SSB burst set transmission occasion, the method further comprises:
transmitting a downlink transmission or receive an uplink transmission using the one or more SSB resources in that SSB burst set transmission occasion.

17. The method of claim 14, further comprising:
transmitting, to one or more UEs, an indication of the SSB transmission periodicity configured for each SSB in the set of SSBs.

18. An apparatus for wireless communication at a user equipment (UE), comprising:
a memory; and
at least one processor coupled to the memory and configured to:
receive, from a base station, information indicative of a synchronization signal block (SSB) transmission periodicity configured for each SSB in a set of SSBs for a time period, the time period including multiple SSB burst set transmission occasions, wherein at least a first SSB and a second SSB in the set of SSBs are configured with different SSB transmission periodicities; and
receive, from the base station, at least one SSB in the set of SSBs based on a corresponding SSB transmission periodicity for the at least one SSB.

19. The apparatus of claim 18, wherein at least one of the multiple SSB burst set transmission occasions transmits a subset of the set of SSBs.

20. The apparatus of claim 18, wherein if one or more SSB resources in an SSB burst set transmission occasion of the multiple SSB burst set transmission occasions are not used for transmitting SSBs in that SSB burst set transmission occasion, the at least one processor is further configured to:
receive a downlink transmission or transmit an uplink transmission using the one or more SSB resources in that SSB burst set transmission occasion.

21. The apparatus of claim 20, wherein the downlink transmission or the uplink transmission is periodic or semi-persistent.

22. The apparatus of claim 21, wherein the downlink transmission or the uplink transmission includes at least one of: a channel state information (CSI)-reference signal (RS) (CSI-RS), a sounding reference signal (SRS), a configured grant (CG) physical uplink shared channel (PUSCH), or a semi persistent scheduling (SPS) physical downlink shared channel (PDSCH).

23. The apparatus of claim 18, wherein the information is at least partially received via a system information block type 1 (SIB 1) message.

24. The apparatus of claim 23, wherein a portion of the information is received via an other system information (OSI) message.

25. The apparatus of claim 18, wherein the at least one processor is further configured to:
receive, from the base station, an indication not to monitor for a control resource set #0 (CORESET #0) in an SSB burst set transmission occasion of the multiple SSB burst set transmission occasions if the SSB burst set transmission occasion transmits a subset of the set of SSBs; and
skip monitoring the CORESET #0 for one or more SSB burst set transmission occasions that do not transmit the set of SSBs.

26. The apparatus of claim 18, wherein each SSB in the set of SSBs is transmitted via a corresponding SSB beam of the base station, and wherein the SSB transmission periodicity configured for each SSB in the set of SSBs is based at least in part on a probability or statistic associated with a number of user equipments (UEs) communicating with the base station via the corresponding SSB beam during the time period.

27. The apparatus of claim 26, wherein the probability or the statistic associated with the number of UEs communicating with the base station via the corresponding SSB beam during the time period includes the number of UEs performing random-access channel (RACH) procedures with the base station via the corresponding SSB beam during the time period.

28. A method for wireless communication at a user equipment (UE), comprising:
receiving, from a base station, information indicative of a synchronization signal block (SSB) transmission periodicity configured for each SSB in a set of SSBs for a time period, the time period including multiple SSB burst set transmission occasions, wherein at least a first SSB and a second SSB in the set of SSBs are configured with different SSB transmission periodicities; and
receiving, from the base station, at least one SSB in the set of SSBs based on a corresponding SSB transmission periodicity for the at least one SSB.

29. The method of claim 28, wherein if one or more SSB resources in an SSB burst set transmission occasion of the multiple SSB burst set transmission occasions are not used for transmitting SSBs in that SSB burst set transmission occasion, the method further comprises:
receiving a downlink transmission or transmit an uplink transmission using the one or more SSB resources in that SSB burst set transmission occasion.

30. The method of claim 28, further comprising:
receiving, from the base station, an indication not to monitor for a control resource set #0 (CORESET #0) in an SSB burst set transmission occasion of the multiple SSB burst set transmission occasions if the SSB burst set transmission occasion transmits a subset of the set of SSBs; and
skipping monitoring the CORESET #0 for one or more SSB burst set transmission occasions that do not transmit the set of SSBs.
